(19) United States
(12) Patent Application Publication
(10) Pub. No.: US 2025/0362794 A1
(43) Pub. Date: Nov. 27, 2025

(54) SYSTEMS AND METHODS FOR ENHANCED VISUALIZATION OF ELECTRONIC DATA

(71) Applicant: Lee Labs, LLC, San Francisco, CA (US)

(72) Inventors: Albert LEE, Hillsborough, CA (US); Michael LEE, San Francisco, CA (US); Nicholas LAU, San Francisco, CA (US); Warren WAN, Pasadena, CA (US); Emily HOM-NICI, Brooklyn, NY (US); Ben MCALLISTER, Chapel Hill, NC (US)

(21) Appl. No.: 19/214,849

(22) Filed: May 21, 2025

Related U.S. Application Data
(60) Provisional application No. 63/650,653, filed on May 22, 2024.

(51) Int. Cl. G06F 3/04847; G06F 3/04812; G06F 11/32

(52) U.S. Cl. CPC G06F 3/04847; G06F 3/04812; G06F 11/327

(57) ABSTRACT

A computer system for managing metrics on a data management application is provided. The computer system may include: at least one processor; a user interface configured to present an electronic data management application and a metrics toolbar; and at least one memory storing instructions that are executable by the at least one processor, wherein the instructions cause the at least one processor to: receive a user selection of a metric type from a predefined set of metric types; receive one or more configuration parameters associated with the selected metric type; and generate a visual representation of the configured metric within a metrics toolbar presented on the electronic data management application, wherein the visual representation comprises a computed metric value based on scheduled event data and the configuration parameters.

### CROSS REFERENCE TO RELATED APPLICATION

The application claims priority to U.S. Provisional Application No. 63/650,653, filed on May 22, 2024, which is incorporated by reference herein in its entirety.

### TECHNICAL FIELD

The present disclosure relates generally to the field of data analytics, management, and visualization and, more particularly, to systems and methods for managing multiple electronic data organization tools and enhancing the prioritization and display of related data.

### BACKGROUND

The prevalence of electronic data organization tools in modern society, such as electronic calendars, has transformed the way that individuals manage their time and commitments. However, the existing landscape of calendar systems presents a number of inherent challenges, especially as individuals navigate between multiple calendars for work, personal, and family obligations. For instance, some common issues include: the inconvenience of checking multiple calendars, the trade-off between information visibility and clarity, incomplete representations of commitments, and the static nature of calendar views. In view of the foregoing, traditional electronic calendars generally lack the precision and adaptability needed to seamlessly integrate various commitments, which often results in fragmented scheduling and potential oversights.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are provided for optimized data visualization within calendar systems.

In one aspect, a computer system for managing metrics on a data management application is provided. The computer system may include: at least one processor; a user interface configured to present an electronic data management application and a metrics toolbar; and at least one memory storing instructions that are executable by the at least one processor, wherein the instructions cause the at least one processor to: receive a user selection of a metric type from a predefined set of metric types; receive one or more configuration parameters associated with the selected metric type; and generate a visual representation of the configured metric within a metrics toolbar presented on the electronic data management application, wherein the visual representation comprises a computed metric value based on scheduled event data and the configuration parameters.

In another aspect, a computer-implemented method for managing metrics on a data management application is provided. The computer-implemented method may include: receiving, at a user interface configured to present an electronic data management application and a metrics toolbar and using a processor associated with the data management application, a user selection of a metric type from a predefined set of metric types; receiving, using the processor, one or more configuration parameters associated with the selected metric type; and generating, using the processor, a visual representation of the configured metric within a metrics toolbar presented on the electronic data management application, wherein the visual representation comprises a computed metric value based on scheduled event data and the configuration parameters.

In yet another aspect, at least one non-transitory computer-readable medium storing instructions for managing metrics on a data management application is provided. The at least one non-transitory computer-readable medium may include instructions, when executed by at least one processor, causing the at least one processor to perform operations including: receiving, at a user interface configured to present an electronic data management application and a metrics toolbar, a user selection of a metric type from a predefined set of metric types; receiving one or more configuration parameters associated with the selected metric type; and generating a visual representation of the configured metric within a metrics toolbar presented on the electronic data management application, wherein the visual representation comprises a computed metric value based on scheduled event data and the configuration parameters.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of any embodiment will be pointed out in the appended claims.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system infrastructure for executing the techniques described herein, according to one or more embodiments of the present disclosure.

FIG. 2 depicts an exemplary calendar configured to leverage certain “layers” features, according to one or more embodiments of the present disclosure.

FIGS. 3A and 3B depict exemplary selection states of an availability control, according to one or more embodiments of the present disclosure.

FIGS. 4A and 4B depict additional exemplary states of an availability control, according to one or more embodiments of the present disclosure.

FIGS. 5A and 5B depict additional exemplary states of an availability control, according to one or more embodiments of the present disclosure.

FIG. 6 depicts a process for implementing a selection on an availability control, according to one or more embodiments of the present disclosure.

FIG. 7 depicts an exemplary option flow for responding to an RSVP event, according to one or more embodiments of the present disclosure.

FIGS. 8A and 8B depict exemplary selections associated with a shared calendar, according to one or more embodiments of the present disclosure.

FIG. 9 depicts an exemplary event scheduler popup, according to one or more embodiments of the present disclosure.

FIG. 10 depicts an exemplary calendar overview, according to one or more embodiments of the present disclosure.

FIG. 11 depicts an exemplary event scheduler, according to one or more embodiments of the present disclosure.

FIG. 12 depicts an exemplary event preview screen, according to one or more embodiments of the present disclosure.

FIG. 13 depicts an exemplary tag bar, according to one or more embodiments of the present disclosure.

FIG. 14 depicts an exemplary calendar interface, according to one or more embodiments of the present disclosure.

FIG. 15 depicts an exemplary calendar interface, according to one or more embodiments of the present disclosure.

FIG. 16 depicts an exemplary calendar interface, according to one or more embodiments of the present disclosure.

FIG. 17 depicts an exemplary multi-calendar overview screen, according to one or more embodiments of the present disclosure.

FIG. 18 depicts an exemplary lens interface, according to one or more embodiments of the present disclosure.

FIG. 19 depicts an exemplary theme selection preview, according to one or more embodiments of the present disclosure.

FIGS. 20A to 20D depict an exemplary search interfaces, according to one or more embodiments of the present disclosure.

FIG. 21 depicts an exemplary rule designation interface for assigning a tag to an event, according to one or more embodiments of the present disclosure.

FIG. 22 depicts an exemplary interface showing a metrics toolbar, according to one or more embodiments of the present disclosure.

FIG. 23 depicts non-limiting display variants of a metrics toolbar, according to one or more embodiments of the present disclosure.

FIG. 24 depicts characteristics of a metrics toolbar, according to one or more embodiments of the present disclosure.

FIG. 25 depicts additional characteristics of a metrics toolbar, according to one or more embodiments of the present disclosure.

FIG. 26 depicts characteristics associated with a Free Time metric, according to one or more embodiments of the present disclosure.

FIG. 27 depicts characteristics associated with a Focus Time metric, according to one or more embodiments of the present disclosure.

FIG. 28 depicts characteristics associated with a countdown metric, according to one or more embodiments of the present disclosure.

FIG. 29 depicts characteristics associated with a Time Since metric, according to one or more embodiments of the present disclosure.

FIG. 30 depicts characteristics associated with an Event Count metric, according to one or more embodiments of the present disclosure.

FIG. 31 depicts characteristics associated with another Event Count metric, according to one or more embodiments of the present disclosure.

FIG. 32 depicts characteristics associated with a Streak metric, according to one or more embodiments of the present disclosure.

FIG. 33 depicts a user interface, according to one or more embodiments of the present disclosure.

FIG. 34 depicts a Free Time metric, according to one or more embodiments of the present disclosure.

FIG. 35 depicts a user interface, according to one or more embodiments of the present disclosure.

FIG. 36 depicts a user interface, according to one or more embodiments of the present disclosure.

FIG. 37 depicts a user interface, according to one or more embodiments of the present disclosure.

FIG. 38 depicts a user interface, according to one or more embodiments of the present disclosure.

FIG. 39 depicts a user interface, according to one or more embodiments of the present disclosure.

FIG. 40 depicts a configuration interface, according to one or more embodiments of the present disclosure.

FIG. 41 depicts a configuration interface, according to one or more embodiments of the present disclosure.

FIG. 42 depicts a configuration interface, according to one or more embodiments of the present disclosure.

FIG. 43 depicts a configuration interface, according to one or more embodiments of the present disclosure.

FIG. 44 depicts a metrics toolbar, according to one or more embodiments of the present disclosure.

FIG. 45 depicts alert explanations, according to one or more embodiments of the present disclosure.

FIG. 46 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “about,” and “generally,” are used to indicate a possible variation of ±10% of a stated or understood value.

As used herein, the term “information handling device” generally encompasses virtually any type of electronic computing device including, for example, laptop and/or personal computers, smart phones, tablet devices, wearable devices, hybrid devices, other types of user devices, and the like. The term “information handling device” may be used interchangeably with, or in place of, any or all of the aforementioned types of computing devices. Additionally, utilization of one of the foregoing terms over another may not be intended to be limiting unless explicitly designated as such.

In contemporary society, the reliance on data organization tools, such as electronic calendars, has become indispensable for managing time and commitments. However, a universal challenge persists as individuals contend with the complexity of juggling multiple calendars and/or single calendars that are filled with an overabundance of information. Conventional calendar systems, while widely adopted, are inherently limited in their ability to seamlessly integrate disparate commitments and to intelligently manage the volume and types of information that are displayed, thereby leading to inefficiencies in time management and attention allocation.

One conventional issue that many individuals encounter is the inconvenience of consulting multiple calendars to acquire the total information they need. More particularly, conventional electronic calendars often segregate commitments into different calendars, such as ones related to work, personal matters, and family. This separation makes it challenging for individuals to obtain a holistic view of their schedule and may also lead to potential oversights. In a similar vein, managing commitments across different calendars often involves manual effort (e.g., an individual may need to manually duplicate an event on multiple calendars to ensure accurate representation of their availability), which may be time-consuming, burdensome, and prone to errors. As another issue, conventional calendars primarily focus on events with specific time constraints, neglecting tasks and commitments that are not tied to a particular time. This results in an incomplete view of an individual's total commitments, with the risk of neglecting important tasks in favor of urgent, time-bound events. Furthermore, in yet another example issue, contemporary electronic calendars generally mimic traditional paper calendars, lacking the adaptability needed for diverse scheduling needs. Specifically, users are often confined to static views that may not align with the dynamic nature of their tasks, whether it be planning a work week or organizing a vacation.

The present disclosure is accordingly directed to systems and methods that redefine the technical landscape of electronic calendars by introducing a dynamic and integrated event prioritization and presentation system. The present disclosure provides a novel approach that optimizes data visualization within a calendar application (also referred to herein as a “data management application”). This approach enables users to dynamically organize and display calendar data (also referred to herein as “event data”) based on various user-defined metrics, as further described herein. By providing flexible views and an integrated task management features, the concepts described herein deliver a unified and efficient solution to the challenges posed by conventional electronic calendars.

The methods and systems described herein represent a variety of technical improvements to computer technology, in the field of data analytics, data management, and data visualization. For example, the introduction of layered event viewing (e.g., through implementation of event prioritization along a digital “z-axis”) represents a fundamental shift in how events are organized and presented in electronic calendars to enhance visualization efficiency and effectiveness. More particularly, through the embodiments associated with the “layers” concept described herein, events from multiple calendars may be co-displayed on a single screen, thereby negating a need for a user to utilize multiple computing devices, and/or multiple applications on computing devices, to view the entirety of their relevant calendar data. Furthermore, layered event viewing leverages an additional digital dimension that conventional calendars had not previously utilized, thereby enabling the concepts described herein to present more information to a user, in a clearer way, and all while occupying less digital real estate. Furthermore, novel visualization techniques, such as color-coded tags and customizable themes, contribute to an improved user interface, which may enhance a user's interaction with the computer system.

Additionally to the foregoing, the rule-based tagging and the advanced search functionalities described herein go beyond basic organizational concepts. Specifically, the ability to automatically apply tags based on search criteria involves a technical approach to event management that has not been conventionally explored. Additionally, the dynamic assignments of tags based on user behavior or automated analysis contributes to an intelligent and user-friendly system that adapts to user preferences over time. Furthermore, the customization capabilities introduced by the “lenses” concept,” e.g., the ability to save and apply rulesets for displaying events in different contexts, may represent a technical solution that improves user customization as well as customized visualization capabilities. All of the foregoing enhancements and customization options to a calendar-based user interface may represent technical solutions to real-world problems.

Furthermore, the dynamic nature by which various graphical user interface (GUI) icons and/or visual elements associated with the electronic calendar are represented may exemplify a specific improvement over conventional systems. Specifically, the position and/or visual appearance of various icons and/or elements of the electronic calendar may be automatically adjusted based on identified user preference data (e.g., deduced from prior user inputs to a calendaring application, dynamically determined from user interactions with other applications, dynamically determined from data received from other applications, etc.) and/or other types of context data associated with a user. These dynamic GUI adjustments require the use of a computer processor and cannot be practically performed in the human mind. Additionally, these unique GUI traits result in an improved user interface for electronic devices that implement the electronic calendar.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

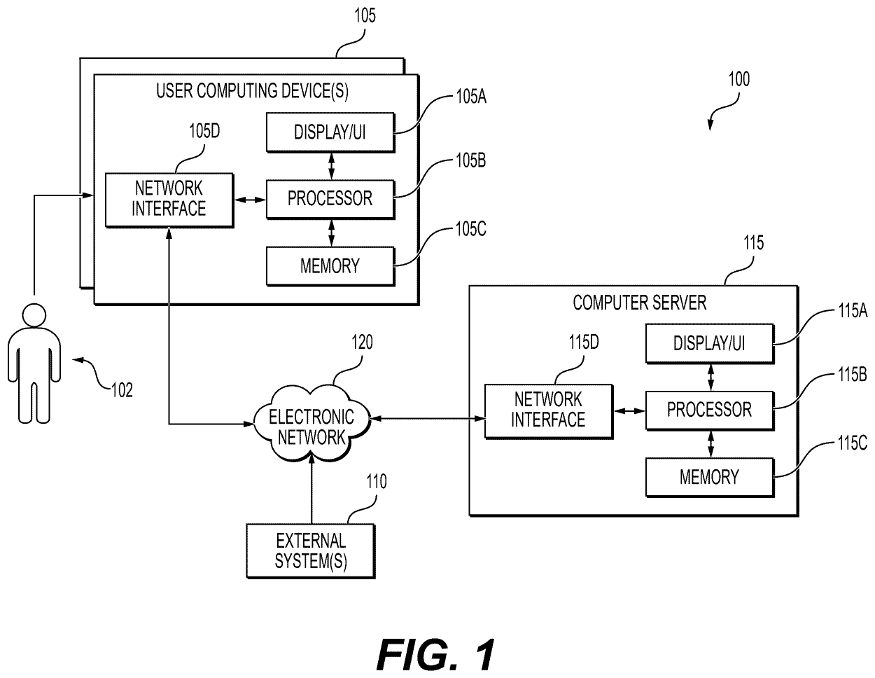

FIG. 1 depicts an exemplary system environment 100 for event visualization that may be utilized with techniques presented herein. A user computing device 105, an external system(s) 110, and a computer server 115 may communicate across a network 120. The user computing device 105 may be associated with a user 102, e.g., a user that interacts with one or more of their electronic data organizers (also referred to herein as calendars, electronic calendars, electronic data management applications, or the like). The external system(s) 110 may be associated with one or more entities that may store and/or communicate data relevant to the user. For example, the external system(s) 110 may be another email or communication platform, a social media platform, another data store containing other types of user information, and the like.

The user computing device 105, the external system 110, and the computer server 115 may be connected via network 120, e.g., using one or more standard communication protocols. The network 120 may comprise one or more networks that connect devices and/or components of system environment 100 to allow communication between the devices and/or components. For example, the network 120 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of environment 100. In some embodiments, the network 120 may be implemented using cell and/or pager networks, satellite, licensed radio, or a combination of licensed and unlicensed radio. The network 120 may be associated with a cloud platform that stores data and information related to methods disclosed herein.

In some embodiments, network 125 includes the Internet, and information and data provided between various systems occurs online. “Online” may refer to connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As shown in FIG. 1, the computer server 115 may be in communication with the user computing device 105 to transmit and receive messages, instructions, and/or other data from each other across the network 120. The user computing device 105 may be associated with a user that is utilizing a data organizer application, such as an email and/or calendaring application, provided by the computer server 115. The computer server 115 may be configured to receive data over the network 120 from the user computing device 105, e.g., new event creations, even modifications, responses to event requests, calendar settings adjustments, etc., and from external system(s) 110, e.g., context data associated with the user such as user availability, user location, user preferences, etc. In some embodiments, the computer server 115 may be a server cluster, or any other collection or network of a plurality of computer servers.

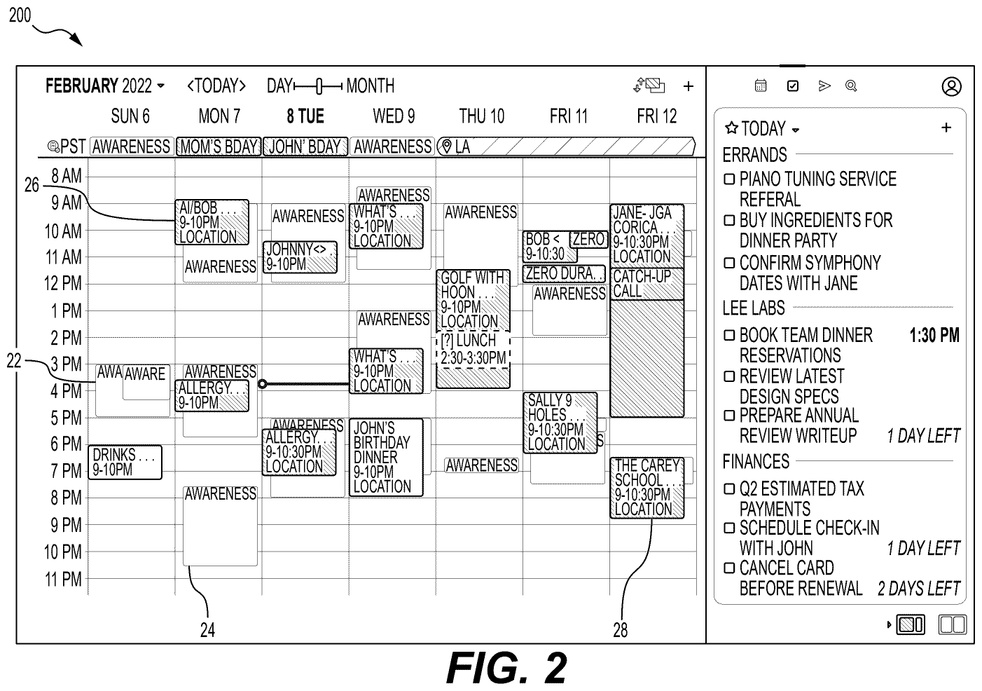

The user computing device 105 may include a display/user interface (UI) 105A, a processor 105B, a memory 105C, and/or a network interface 105D. The user computing device 105 may be a personal computer (PC), a tablet PC, a streaming device, a smart TV, a gaming console, a personal digital assistant (PDA), a mobile device, a palmtop computer, a laptop computer, a desktop computer, or any other information handling device capable of accessing and utilizing features of a calendaring application as described herein. The user computing device 105 may execute, by the processor 105B, an operating system (O/S) and at least one application (each stored in memory 105C). The application may be a browser program or a mobile application program (which may also be a browser program in a mobile O/S). The application may generate one or more interactive graphic user interfaces (GUIs) and/or graphical elements, such as, for example, the exemplary GUIs and elements shown in FIGS. 2-45, based on instructions/information received from the server 115. In some embodiments, the application may generate one or more interactive GUIs based on instructions/information stored in the memory 105C. The interactive GUIs may be application GUIs for the application executed based on XML and Android programming languages or Objective-C/Swift, but one skilled in the art would recognize that this may be accomplished by other methods, such as webpages executed based on HTML, CSS, and/or scripts, such as JavaScript. The display/UI 105A may be a touch screen or a display with other input systems (e.g., mouse, keyboard, etc.). The network interface 105D may be a TCP/IP network interface for, e.g., Ethernet or wireless communications with the network 120. The processor 105B, while executing the application, may receive user inputs from the display/UI 105A, and perform actions or functions in accordance with the application.

External system(s) 110 may be, for example, one or more third-party and/or auxiliary systems that integrate and/or communicate with the server systems 115, 120 in performing various user access control tasks. For example, the external system(s) may include an identity provider that may be configured to validate user login credentials (e.g., by comparison of the user login credentials to a credential database 110A) and issue identity (ID) tokens, as further described herein. External systems 110 may be in communication with other device(s) or system(s) in the environment 100 over the one or more networks 120. For example, external system(s) 110 may communicate with the authorization server 115 via API (application programming interface) access over the one or more networks 120, and may also communicate with the user device(s) 105 via web browser access over the one or more networks 120.

The computer server 115 may include a display/UI 115A, a processor 115B, a memory 115C, and/or a network interface 115D. The server 115 may be a computer, system of computers (e.g., rack server(s)), and/or or a cloud service computer system. The server 115 may execute, by the processor 115B, an operating system (O/S) and at least one instance of a server program (each stored in memory 115C). The server 115 may store or have access to information from external system(s) 120. The display/UI 115A may be a touch screen or a display with other input systems (e.g., mouse, keyboard, etc.) for an operator of the server 115 to control the functions of the server 115 (e.g., update the server program and/or the server information). The network interface 115D may be a TCP/IP network interface for, e.g., Ethernet or wireless communications with the network 120. Computer server 115 may store data associated with user 102 of user computing device 105. For instance, computer server 115 may store contact information for other individuals user 102 is associated with, settings data for one or more calendars used by user 102, event data associated with the one or more calendars, and the like. Additionally or alternatively, computer server 115 may store additional data received from user computing device 105 including real time and/or near real time location data (e.g., GPS data) of the user computing device 105.

### Layering

Conventional digital calendars offer solutions to manage events. However, they fall short in providing a unified and intuitive approach to handle commitments across various calendars. For instance, conventional calendars focus on individual calendars, leading to a fragmented display of availability information. For example, a user's work calendar may not be aware of events on their personal calendar, causing discrepancies in availability representation. Additionally, combining multiple calendars in a single view often results in information overload. In these situations, users must navigate through a cluttered interface, making it challenging to prioritize essential commitments.

To address some or all of the foregoing issues, this section introduces a concept referred to as “layers,” which encompass layered event display and multi-account calendar management. The layers allow users to view multiple calendars simultaneously without sacrificing clarity. They establish a visual hierarchy by presenting foregoing commitments distinctly, while background events provide informational context. Additionally, the utilization of layers enables prioritization of a user's true availability across various calendars. More particularly, it addresses the challenge of calendars being “self-centered” and ensures that an individual's actual availability is accurately represented. Furthermore, a novel availability control is also contemplated, which helps differentiate commitments from informational events. This control, applied consistently across event types, may simplify the manipulation of layers for personal and work events. Additionally still, through dynamic layer manipulation, users may independently manipulate attributes such as attendance, attention, and availability for each event. This feature ensures that users can customize their calendar experience and visibility according to their preferences. Additionally still, users may utilize layers to address challenges specific to family calendars, e.g., where events are shared among multiple users.

Referring now to FIG. 2, an exemplary calendar 200 configured to leverage the foregoing types of “layering” features is presented herein. Calendar 200 may be configured to function in accordance with the modules and components of system 100 above.

In an aspect, calendar 200 may contain a listing of events from a single calendar associated with a user (e.g., calendar 200 may only display events from the user's work calendar, personal calendar, family calendar, etc.). Alternatively, in another aspect, calendar 200 may contain an amalgamation of events obtained from two or more user calendars (e.g., calendar 200 may display some or all events from a user's work calendar, personal calendar, and family calendar).

To reduce clutter and improve clarity, calendar 200 may be configured to contain both a background layer and a foreground layer. Events in the background layer may be situated there for informational purposes. More particularly, these events may represent meetings and/or activities that a user would like to be apprised of, but doesn't want reflecting as hard time commitments to themselves or others. Conversely, events in the foreground layer may represent events that a user is committed to attending and may be more emphasized on calendar 200, as further described herein. It is important to note that the layers feature doesn't simply assign all events from an entire calendar to a single layer (e.g., allocating all events identified on the user's personal calendar to the background layer while simultaneously placing all events identified on the user's work calendar on the foreground layer), but rather, events from any calendar may appear in the background or foreground layer. For instance, all events from a user's work and personal calendar may be represented on a single calendar, and a first subset of those collective events may be situated in the background layer and a second subset may be situated in the foreground layer.

In an aspect, background events (e.g., 22, 24, etc.) may be visually distinguished from foregoing events (e.g., 26, 28, etc.) in various ways. For instance, background layer events may: be presented with fewer details (e.g., events may just contain the event title, events may just contain a generic background layer designation, such as “Awareness,” etc.), be visually de-emphasized (e.g., via greying-out, background blending, etc.), be positioned behind a concurrent foreground event, and the like. Foreground layer events may: be presented with greater information (e.g., a meeting title and description, meeting location, meeting attendees, etc.), be visually emphasized (e.g., by highlighting or bolding a meeting edge, by representing the foregoing event in a different color than the background event, etc.), be positioned in front of a concurrent background event, and the like. It is important to note that any combination of the foregoing techniques for visually distinguishing background events from foregoing events may be utilized. It is also important to note that other techniques for visually distinguishing background events from foreground events, not explicitly described here, may also be utilized.

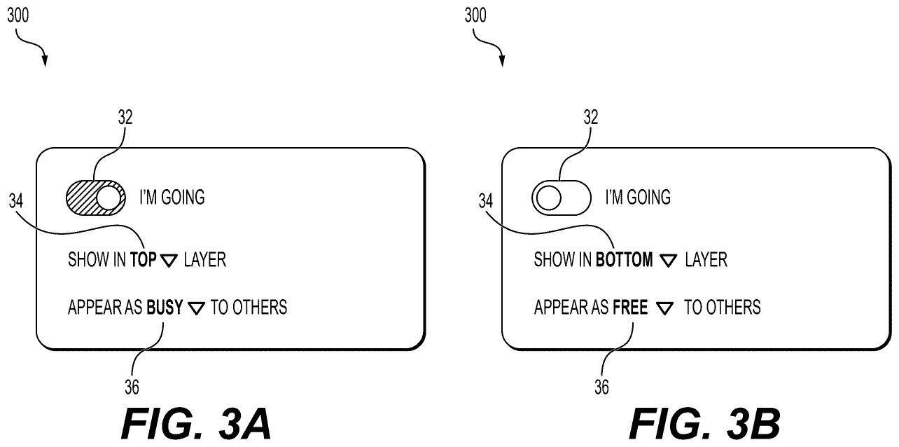

Further to the foregoing, another aspect associated with the “layers” feature is an availability control, also known as an “I'm going” control. The availability control may enable a user to easily differentiate those events they are committed to attending from those events they just want to be apprised of. In an aspect, the attendance control may behave as a type of preset control that sends events to the correct layer (e.g., the background or foreground layer) and adjusts the user's availability accordingly. For instance, referring now to FIGS. 3A and 3B, an availability control 300 is illustrated in two different selection states. The availability control 300 may include an attendance toggle 32, a layer designator 34, and an appearance indicator 36. In FIG. 3A, user selection of the attendance toggle 32 to indicate they will attend an event may institute default settings in the layer designator 34 and appearance indicator 36. More particularly, the relevant event may appear in the foreground, or “top,” layer on their calendar and the user may appear busy to others during the designated duration of the event. Conversely, in FIG. 3B, if the user deselects attendance toggle 32, the event may be moved to the background, or “bottom,” layer on their calendar and the user may appear free to others.

Most practical situations may be correctly categorized by the default settings associated with either the “going” or “not going” selection on the attendance toggle 32. However, users may manipulate these default settings so that they can view their own events exactly as they wish to see them and may correspondingly make their calendar appear to others exactly as they wish it to appear. A plurality of exemplary situations are outlined below that detail how a user may customize settings of the availability control 300 to achieve their desired calendar configuration for an event.

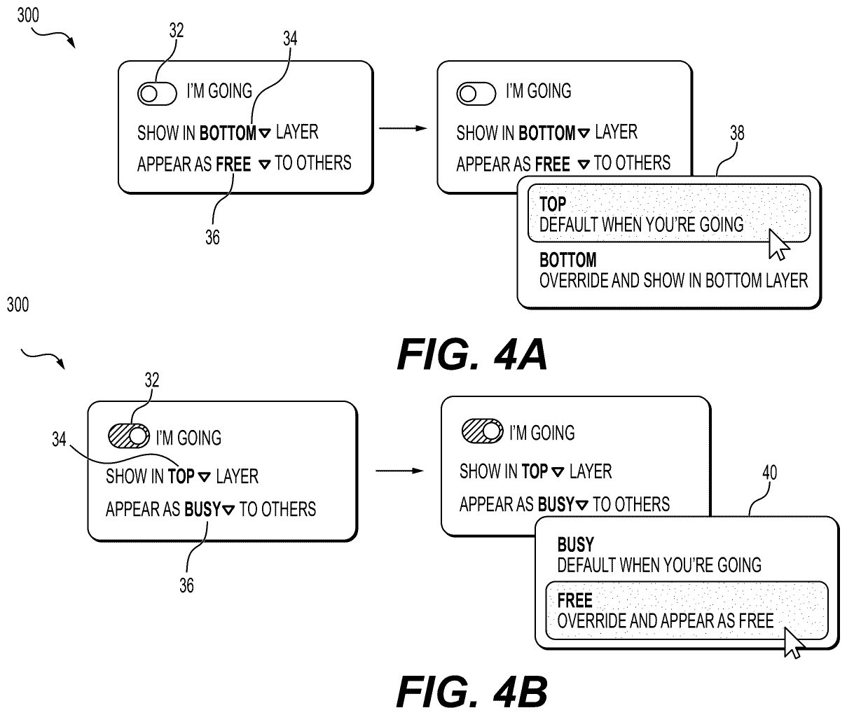

Referring now to FIGS. 4A and 4B, a situation may occur in which a user may want to appear free to others for an event, but may also want to have that event appear in the foreground layer. A user may accomplish this intent in two different ways. In one embodiment, as represented by availability control 300 in FIG. 4A, a user may indicate that they are “not going” via interacting with attendance toggle 32 and may move the event to the top layer by selecting the “top” option in dropdown menu 38 that appears in response to interacting with layer designator 34. In another embodiment, as represented by availability control 300 in FIG. 4B, a user may indicate that they are “going” via interacting with attendance toggle 32 and may designate to others that they are free during the duration of the event by selecting the “free” option in dropdown menu 40 that appears in response to interacting with appearance indicator 36.

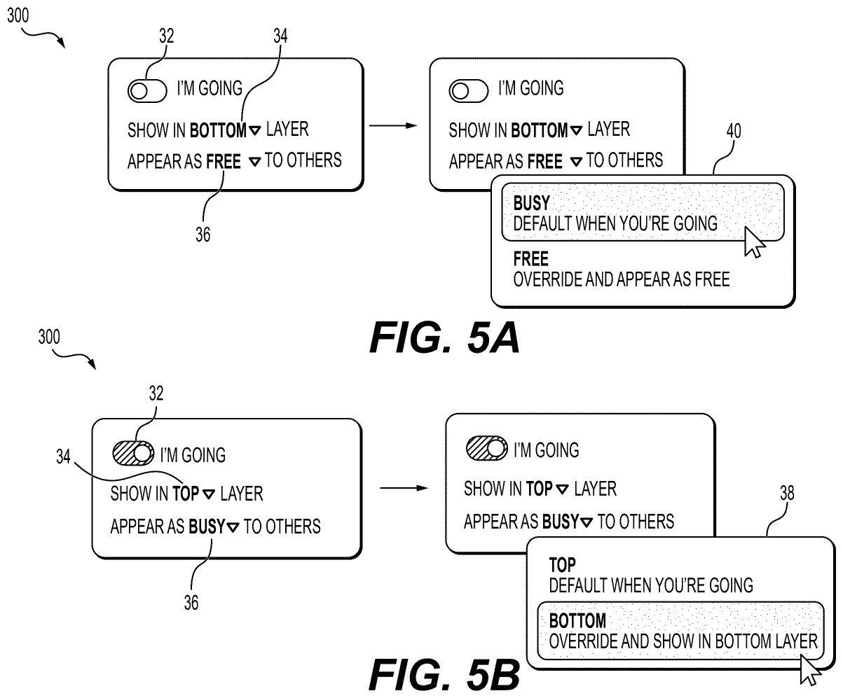

Referring now to FIGS. 5A and 5B, a situation may occur in which a user may want to appear busy to certain individuals (e.g., co-workers, clients, etc.) but may want that event block to appear in the background layer. A user may accomplish this intent in two different ways. In one embodiment, as represented by availability control 300 in FIG. 5A, a user may indicate that they are “not going” via interacting with attendance toggle 32 and may designate to others that they are busy during the duration of the event by selecting the “busy” option in dropdown menu 40 that appears in response to interacting with appearance indicator 36. In another embodiment, as represented by availability control 300 in FIG. 5B, a user may indicate that they are “going” via interacting with attendance toggle 32 and may move the event to the bottom layer by selecting the “bottom” option in dropdown menu 38 that appears in response to interacting with layer designator 34.

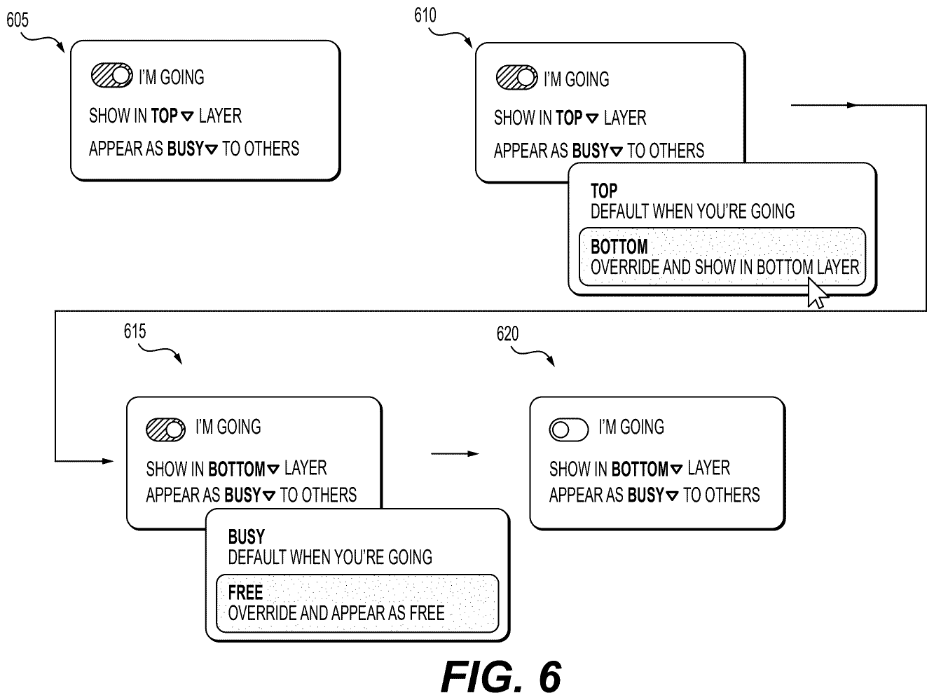

Referring now to FIG. 6, if a user independently adjusts selections in layer designator 34 and appearance indicator 36 to match existing default settings, then system 100 may dynamically adjust attendance toggle 32 to the matching default selection. For instance, availability control 300 at 605 may originally be set to the default settings associated with an “I'm going” selection of attendance toggle 32. If a user adjusts, at 610, layer designator 34 to a background layer and adjusts, at 615, appearance indicator 36 to appear free during the duration of the event, then system 100 may automatically adjust, at 620, attendance toggle 32 to represent a “not going” selection because the selections in layer designator 34 and appearance indicator 36 match the default settings associated with a “not going” selection. An exception to the foregoing is a meeting RSVP. More particularly, if a user accepts an event invitation and subsequently changes their availability during the event to appear as “free” and also assigns the event to the bottom layer, the system 100 would not adjust their initial response to the meeting invite (e.g., system 100 would not update the RSVP response to “not going”).

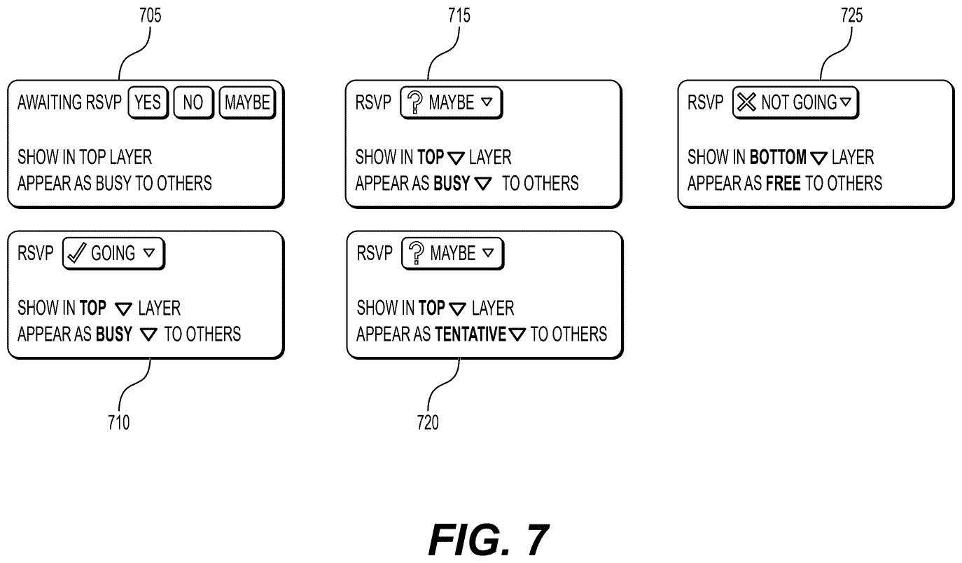

In an embodiment, when a user is invited to an event, the event's RSVP may take the place of the “I'm going” toggle. For instance, referring now to FIG. 7, an exemplary option flow is presented for responding to an RSVP for an event. At 705, a user may receive an invitation to attend an event and may be presented with three options: “yes,” “no,” or “maybe.” If a user indicates that they will attend the event (e.g., by selecting the “yes” option) then the event may be placed in the calendar's top layer, as represented at 710, and the user may appear as “busy” to others, a designation that the user may adjust by interacting with appearance indicator 36. If a user indicates that they may attend the event (e.g., by selecting the “maybe” option), then the event may be placed in the calendar' top layer. In an embodiment, the setting associated with the appearance indictor 36 may be dictated by the email platform the user is utilizing. For instance, the appearance indicator 36 may contain a default setting to appear as “busy” on a first platform, as represented at 715, and a different default setting, e.g., to appear as “tentative”, on a second platform, as represented at 720. If a user indicates that they will not attend the event (e.g., by selecting the “no” option), then the event may be placed in the calendar's bottom layer, as represented at 725, and the user may appear as “free.” In an embodiment, until a user responds to the meeting invitation, the meeting may remain in the user's top layer on their calendar.

Manipulation of the settings in an availability control may be relatively straightforward when dealing with personal and/or work-based events, as previously described above. However, events on shared calendars (e.g. a family calendar) operate differently. For instance, most properties of events are shared among each member in the calendar group. More particularly, if a user changes the appearance designation for an event in a shared calendar, the designation changes for all users that can see the calendar. Accordingly, when a user selects an “I'm going” option via interaction with an attendance toggle for a shared calendar, system 100 may write “I'm going” selection, the “appear as” value, and the “layer” value to a user-specific event property database. The appearance indicator remains unchanged in the underlying event. In an aspect, if a user changes the “I'm going” designation in a shared calendar, it will only change the appearance for them. Additionally, a set of blocking preferences may be available for the user to interact with to designate the correct main calendar (e.g., work calendar, personal calendar, etc.) to be blocked at the selected time to represent that the user is busy. In another aspect, an “I'm going” “family feature” option may be available that may enable a user to set/adjust the “I'm going” designation for other family members.

### Popover Window Behavior

In an embodiment, when the user adjusts their attendance status for a repeating meeting, system 100 may need to confirm the user's intention before implementing the requested change. For instance, system 100 may generate one or more follow-up queries to clarify whether they would like to adjust their attendance status for a single event, a plurality of events in a series, or all upcoming events (e.g., for a predetermined period of time, etc.).

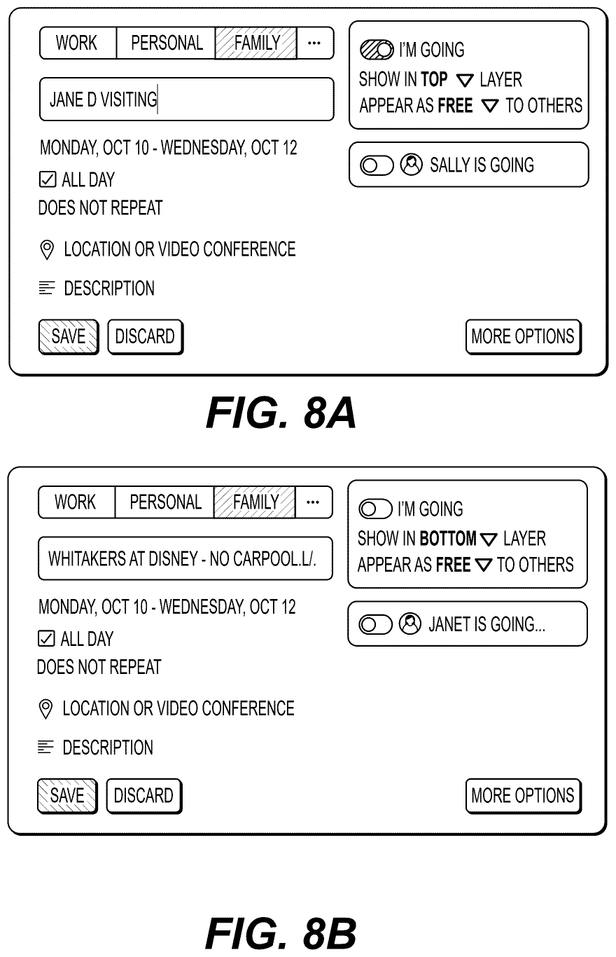

In an embodiment, events that are scheduled to last the entire day, also known as “all-day” events, may be treated in a specialized manner. For instance, the appearance indicator on an availability control may designate that the user is “free,” regardless of the attendance designation that they selected. For instance, in FIG. 8A a user has indicated that they will attend an event, correspondingly causing the event to be listed in the top layer. In FIG. 8B, a user has indicated that they will not attend an event, correspondingly causing the event to be listed in the bottom layer. In both instances, the designation by appearance designator indicates that the user is free during a duration of the event. In an embodiment, the user may manipulate which layer the all-day event appears on (e.g., top or bottom layer). However, the status of attendance toggle may directly correspond to the layer designation and may correspondingly change to reflect the layer adjustment.

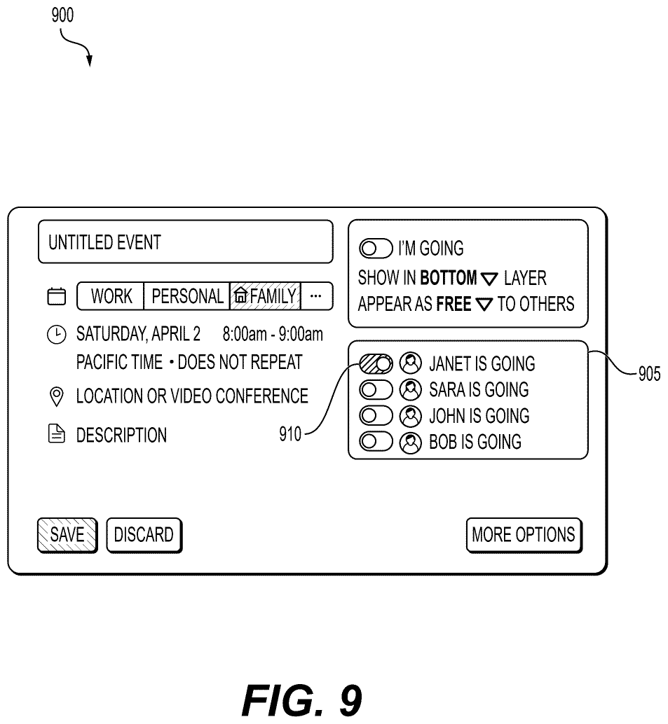

In some situations, event creators may “opt in” other group members to events on the shared calendar. For instance, referring to FIG. 9, an event scheduler popup 900 is presented that may contain, among other things, a group member attendance indicator 905. The group member attendance indicator 905 may list the individuals associated with the shared calendar and may contain an indication of which of these individuals plans to attend the event (e.g., by explicitly indicating in text form whether an individual is going or not, by visually bolding or fading the individual's name, etc.). In an embodiment, a user may opt one of the group members into the event by, for example, interacting with an attendance toggle 910 associated with the target user. Upon opting another user into an event, the “opted-in” user may see an adjustment to their attendance control associated with that event. More particularly, for the opted-in user, the attendance toggle may be adjusted to an “I'm going” designation, the event may be placed in the foreground layer, and their appearance designator may be set to appear as “busy” to others. In an embodiment, the individual that had been opted-in may be notified (e.g., via a notification transmitted by and/or through the calendaring application). In some embodiments, if the other individual has cross-calendar blocking enabled, then their calendar, and corresponding options present in their attendance control, may be blocked from being edited by others.

In an embodiment, certain default settings may exist for newly created events and newly accepted events. With respect to the former, in an embodiment, system 100 may automatically designate the user as “going” to a new event that they created. In another embodiment, system 100 may implement the most recent attendance designation that the user set the last time the user created an event for the relevant calendar. For instance, if the user designated that they were not going to the most recent personal event that they created, then system 100 may automatically assign a “not going” designation to the attendance toggle for the newest created personal event. With respect to the latter, in an embodiment, system 100 may implement a default “not going” attendance designation to events that another individual has created. Additionally or alternatively, system 100 may correspondingly automatically allocate events created by others to the background layer. In an embodiment, all of these default settings may be changed in a settings menu. To make users aware of this setting, the first time a user changes an event's attendance designation on a group calendar for an event that they didn't create, system 100 may prompt the user and ask them to confirm their intention to change the default setting.

### Tags, Lenses, and Rules

The proliferation of information within digital calendars creates a substantial challenge when attempting to extract meaningful insights. Users often open their calendars with specific questions in mind, such as determining the timing of important meetings, identifying free weekends, or understanding the duration until a particular milestone. However, conventional calendars lack the flexibility and tools necessary to provide quick and easy answers to such questions, thereby causing users to engage in laborious searching to identify the information they need.

Conventional attempts to address the foregoing calendar limitations have primarily focused on improving user interfaces and adding features for better event management. However, these attempts fall short in providing the customization and flexibility required to answer diverse questions and scenarios. Specifically, existing calendars lack the ability to save multiple views, highlight specific events dynamically, and automate organizational tasks.

The concepts described in this section introduce three key features to address conventional issues and improve digital calendar visualization: “Tags,” “Lenses,” and “Rules.” Tags are user-defined metadata used to group events, providing a flexible way to categorize and organize information. Users may add tags like “important,” “golf,” or associate a name as a tag with a specific event, thereby enhancing customization. Lenses are user-defined rulesets for displaying events, enabling users to save and switch between multiple customized views. For instance, users can define which events to display, apply color schemes to those events, and set specific views. Rules enable users to automate the application of tags to events based on search criteria. For instance, similar to filters in email systems, rules allow users to tag events automatically, thereby streamlining the organization process.

Tags represent user-defined metadata used to group events together. More particularly, events assigned the same tag may collectively be distinguished from other events on a user's calendar in a simple and intuitive way, as further described herein. In an embodiment, events allocated the same tag may be events that are same (e.g., a recurring event), that share a similar theme or involve a similar activity (e.g., two independent golf outings may both be assigned a “golf” tag, a scheduled run and a scheduled lifting session may both be assigned a “workout” tag, etc.), and/or that may be of equal weight in the eyes of the user (e.g., a critical presentation for work and a child's playoff game may both be tagged as “important,” etc.).

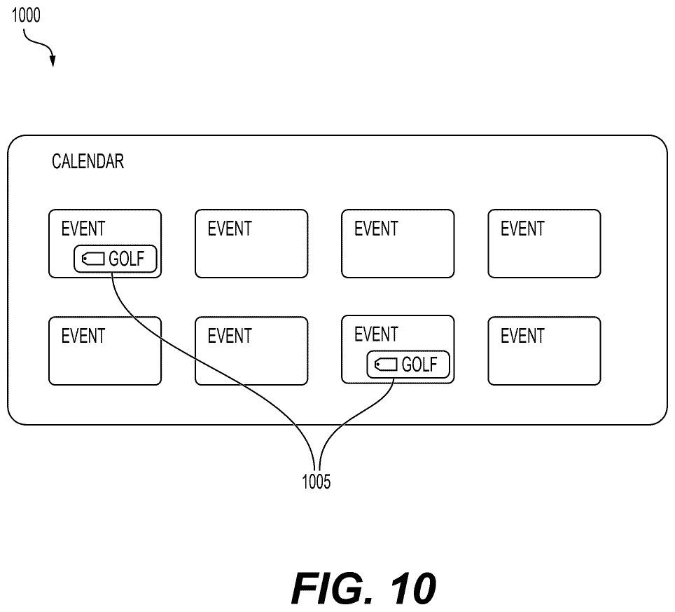

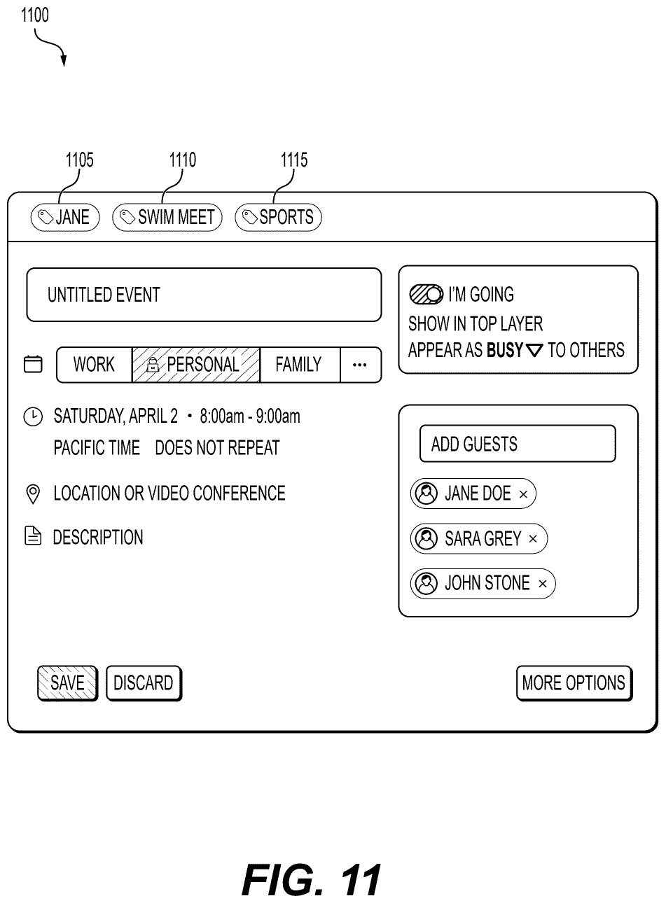

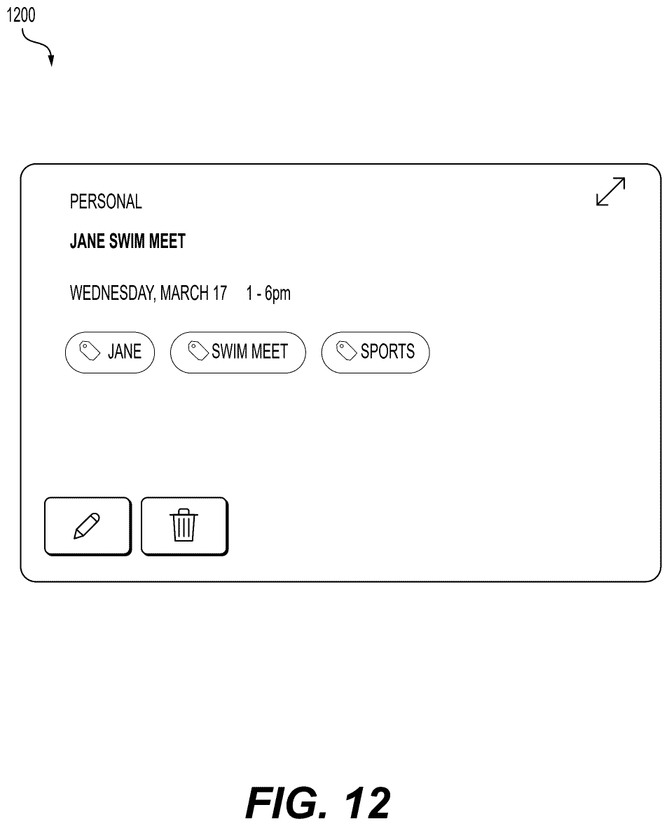

Referring to FIG. 10, an exemplary overview of a user's calendar 1000 is presented. Calendar 1000 may be populated by a plurality of events. A user wanting to associate a subset of those events with one another may add a tag 1005 to the target events, e.g., a user of calendar 1000 may add a “golf” tag to certain golf-related events. In one embodiment, tags may be assigned manually by a user, e.g., when creating or viewing an event. For instance, FIG. 11 presents an event scheduler 1100 that a user may interact with to construct a new event. The event scheduler 1100 may enable a user to add one or more tags that they would like the event associated with. For example, event scheduler 1100 contains three tags for “Olivia” 1105, “swim meet” 1110, and “sports” 1115. In an embodiment, the user may see the tags displayed when subsequently viewing the event, as shown in event preview 1200 in FIG. 12.

In another embodiment, system 100 may assign tags to events dynamically in one or more different ways. For instance, system 100 may identify that a user has previously manually assigned a tag to an event and may thereafter dynamically assign the same tag to a similar upcoming event. For example, responsive to identifying that a user has tagged a meeting with Individual A as important, system 100 may dynamically tag each future meeting with Individual A as important. As another example, system 100 may attempt to automatically assign relevant tags to each newly created or accepted event by, for example, analyzing subject matter associated with the event (e.g., contained in the event subject line, event description, event date, event duration, event location, invite list, etc.). For example, responsive to identifying a newly created event titled “scuba diving” that is scheduled to occur far away from the user's home (e.g., in a Caribbean island when the user lives in Washington), with the user's children, system 100 may add a “vacation” tag to the target event. In some embodiments, system 100 may automatically assign a tag to an event responsive to determining that a certain tag should be associated with a certain event. In another embodiment, system 100 may query the user to confirm the tag before it is assigned. In another embodiment, system 100 may initially provide a suggestion of a tag (e.g., during the first iteration of the event) that must be user-confirmed prior to formal implementation. Upon further iteration of the same or similar event, system 100 may obtain higher confidence in the tag assignments, and may, in some aspects, be configured to assign the tag automatically (e.g., without the need to receive any user confirmation input).

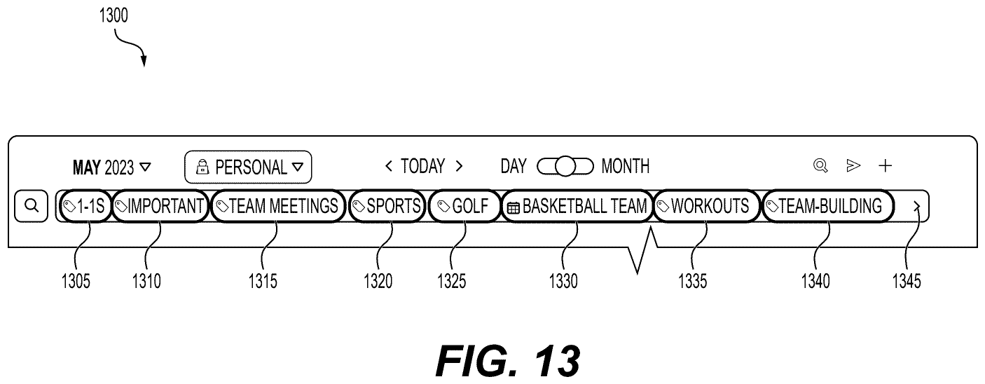

Referring now to FIG. 13, a tag bar 1300 is presented that is configured to provide users with a quick and accessible way to change how events are displayed. The tag bar 1300 may be integrated with and co-displayed with the user's calendar and may contain a scrollable listing of all tags that the events in the user's calendar have been associated with. For example, FIG. 13 illustrates that the events in a user's calendar include tags such as “1-1s” 1305, “important” 1310, “team meetings” 1315, “sports” 1320, “golf” 1325, “Golden State Warriors” 1330, “workouts” 1335, and “team building” 1340. Tag bar 1300 may contain a scroll icon 1345 that may be configured to dynamically appear when there are more tags than are able to be wholly presented in a single line of tag bar 1300. Upon selection of scroll icon 1345 by the user, additional tags that were not originally presented in the tag bar 1300 may be seen.

In an embodiment, the order of the tags 1305-1340 in tag bar 1300 may be presented in a variety of different ways. For instance, system 100 may be configured to chronologically populate the tag bar 1300 with new tags, from left to right, in the order that they are created (e.g., the “oldest” tag may be presented in the far left of the tag bar 1300 and the newest tag may be presented on the far right). Conversely, system 100 may be configured to present the newest tags in the far left position of the tag bar 1300 and gradually move existing tags to the right (or off-screen if the tag bar 1300 becomes over-populated). In another embodiment, system 100 may be configured to organize tags intelligently, e.g., based on certain contextual factors. For instance, tags associated with events that are upcoming earlier may be positioned on tag bar 1300 before tags associated with events that are scheduled to occur later. As another example, tags associated with a greater number of events may be positioned on tag bar 1300 before tags associated with a fewer number of events. In an embodiment, a user may adjust the position of any of the tags in tag bar 1300 (e.g., by selecting and dragging the target tag to the desired position). In an embodiment, once all events containing a particular tag have occurred, the relevant tag may dynamically be removed from the tag bar 1300.

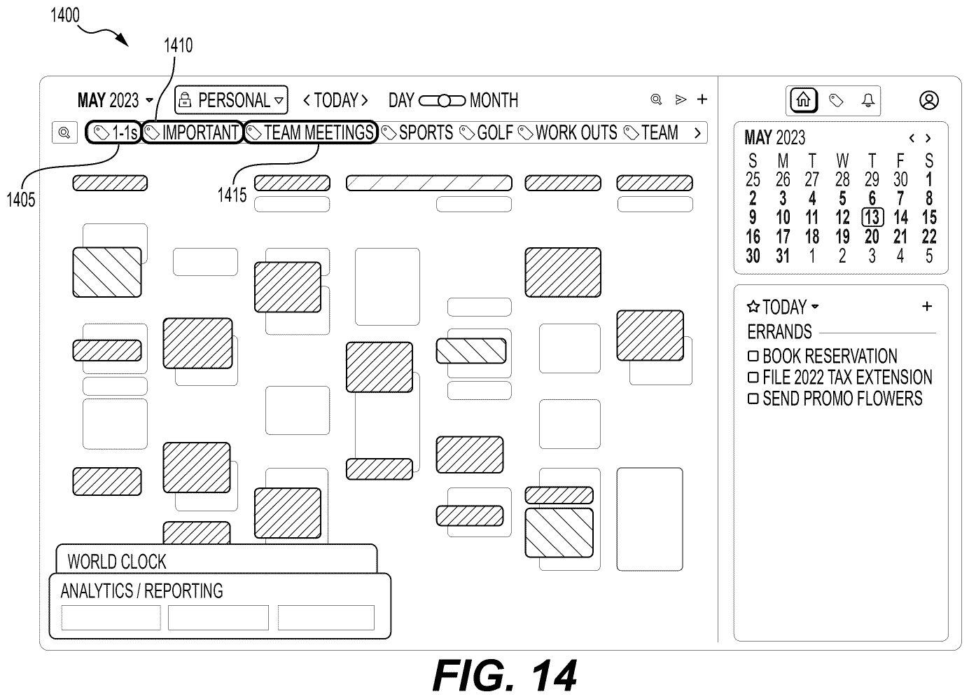

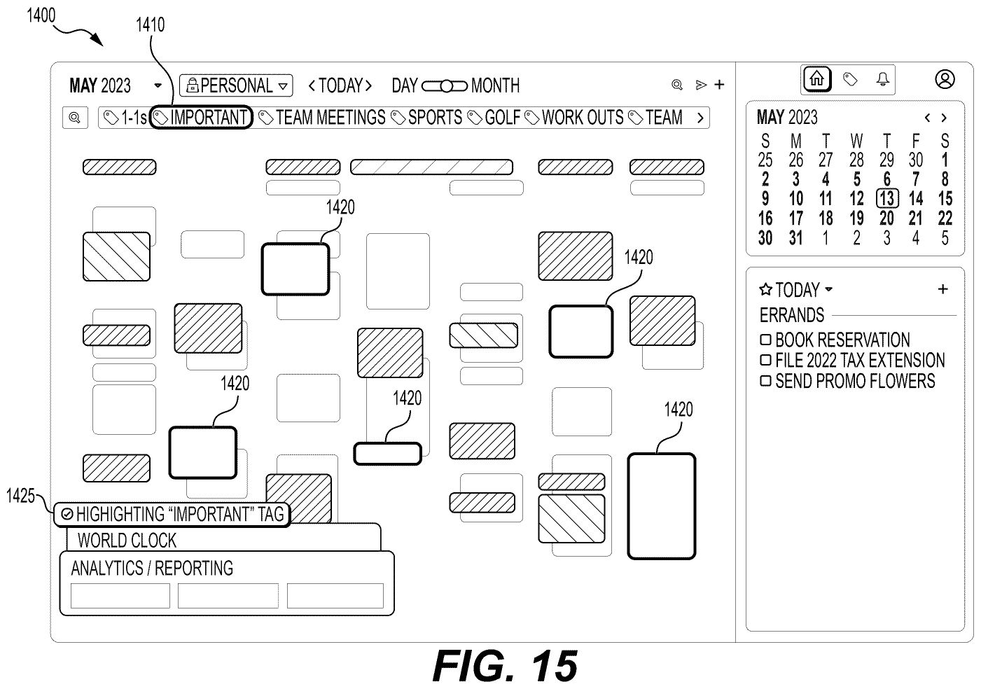

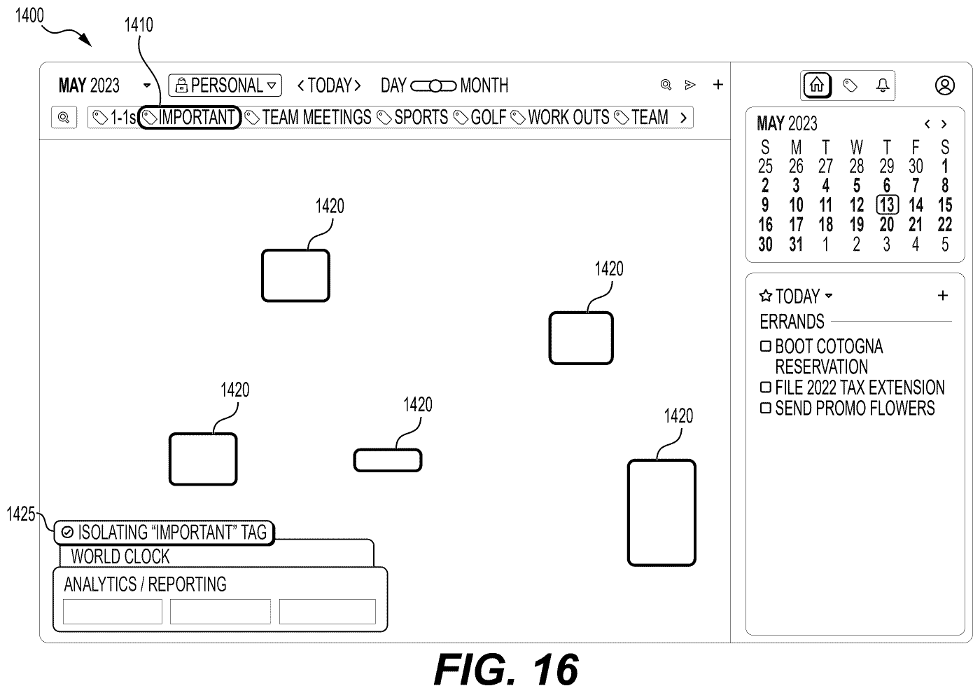

In an embodiment, the user may visually distinguish events having a certain tag from other events via interactions with the tag bar 1300. For instance, referring now collectively to FIGS. 14-16, a process is illustrated for visually distinguishing tagged events. FIG. 14 illustrates a calendar 1400 containing a plurality of events situated in both the foreground and the background layer. Upon user selection of the “important” tag 1410 in tag bar 1405, all events 1420 tagged as “important” will be visually distinguished from other events that did not have that tag, as shown in FIG. 15. For instance, all tagged events 1420 may be presented with a specific color, may have a bolded border, etc. Correspondingly, the “important” tag 1410 may be visually distinguished (e.g., via highlighting, coloring, shading, etc.) from other tags in the tag bar 1405 to reflect this selection. Additionally or alternatively to the foregoing, a popup notification 1425 may be displayed to the user indicating which tag was highlighted. As another example of the foregoing process, selection of the “important” tag 1410 may cause all other events not tagged as “important” to be temporarily removed from calendar 1400, as shown in FIG. 16.

In an embodiment, an increasing visual emphasis on the tagged events may occur from repetitive user interaction with an event tag in the tag bar 1405. For instance, a user may select the “important” tag 1410 once to visually emphasize the “important” events, as shown in FIG. 15, and upon selecting the “important” tag again, all other events not designated as “important” may be temporarily removed from the calendar 1400, as shown in FIG. 16. In another scenario, not explicitly pictured, in some embodiments a user may select a tag once to visually de-emphasize the corresponding tagged events (e.g., by graying out) and may further visually de-emphasize the tagged events (e.g., by excluding them from view) upon a subsequent selection of the tag. In some aspects, this de-emphasis feature may be actuated from the GUI screen or may actuated from another screen or device (e.g., a keyboard option may be configured to perform the tagged event de-emphasis). In an embodiment, a user may select more than one tag from the tag bar 1405. For instance, the user may select the “important” tag 1410 as well as the “team meetings” tag 1415. Upon this dual-tag selection, all events having the tag “important” or “team meetings” may be visually distinguished from the other events in the calendar 1400.

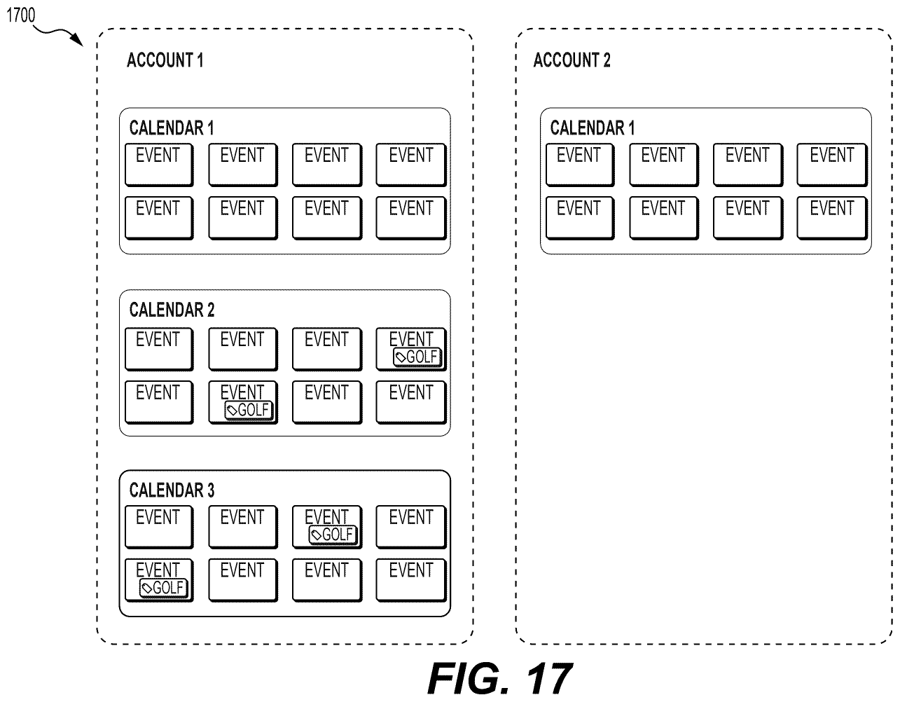

Turning now to the concept of “lenses”—while “tags” give the user the power to customize what they see, “lenses” give the user the power to save those customizations. More particularly, in the context of this application, “lenses” are user-defined, save-able rulesets that may control: which events to display, which colors to apply to each event, which calendar view to default to, whether to override an event's default layer, and the like. Through the combined use of “tags” and “lenses,” users may create the best view to suit every need. For example, with reference to FIG. 17, an exemplary overview 1700 is presented of a plurality of user calendars across two different user accounts. Each calendar may have a dedicated purpose or theme (e.g., a work-based calendar, a personal calendar, a family calendar, etc.) and may contain events related to that theme. Upon instructing/toggling a lens to display any events having a specific tag (e.g., “golf”), then each tagged event may be shown to the user, regardless of whether the calendar is selected or not.

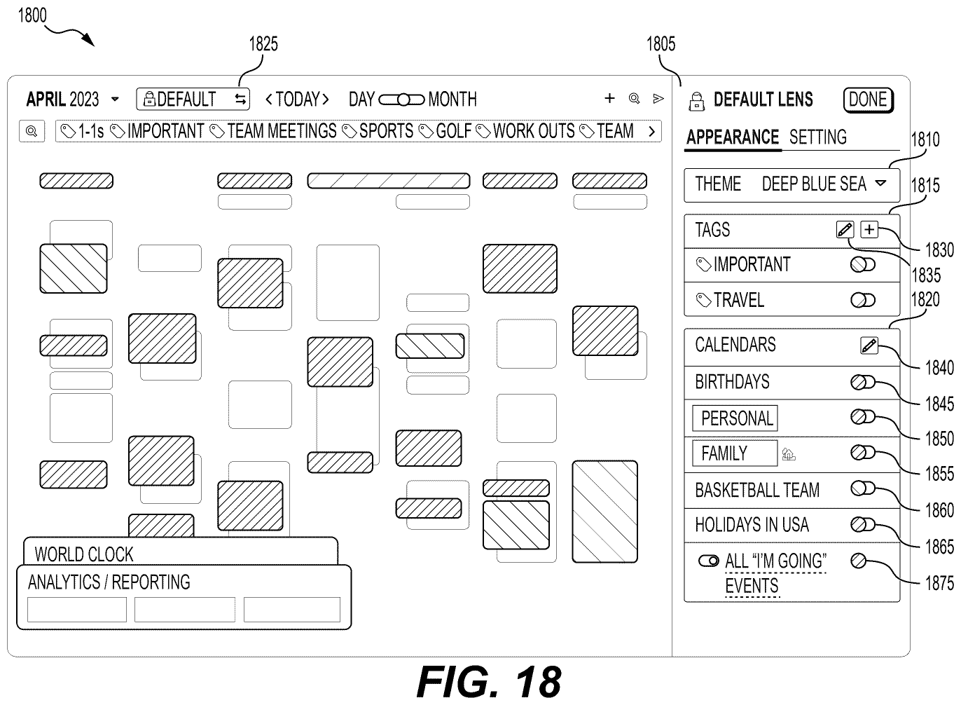

Referring now to FIG. 18, an exemplary lens interface 1800 is presented according to an embodiment. A user may interact with a lens control panel 1805 to select specific tags and calendars to display and also to customize how the events in the calendar are presented. The lens control panel 1805 may contain a theme selector 1810, a tag settings panel 1815, a calendar settings panel 1820, and a lens selector toggle 1825, aspects of all of the foregoing are further described herein.

To open the lens control panel 1805, a user may, for example, select the lens selector toggle 1825. Lens selector toggle 1825 may always provide an indication to the user of a currently active lens (e.g., in FIG. 18 a “Default” lens is displayed). A user may select, via interaction with the lens selector toggle 1825, a particular lens that they would like to edit. Subsequent to this selection, the lens control panel 1805 may appear on the screen for the selected lens and may enable a user to customize settings associated with it.

A user may interact with a tag settings panel 1815 to adjust the appearance of tagged events for a particular lens. A user may select one or more existing tags to include in the selected lens via interaction with icon 1830 and may customize the color assignment associated with the events containing the included tag(s) by interacting with icon 1835. For instance, tag settings panel 1815 in FIG. 18 includes two designated tags, “important” and “travel”. The “important” tag has a peach color assignment (represented by vertical striped lines) and the “travel” tag has a yellow color assignment (represented by the horizontal striped lines). If a user has indicated that they will be attending an event tagged as “important” or an event tagged as “travel,” and the current lens is active, then those events may be displayed with the designated colors orange and yellow, respectively.

In an embodiment, the order of events listed in the tag settings panel 1815, from top to bottom, may represent a hierarchical prioritization of color assignments. More particularly, a single event may contain multiple tags. In such a situation, the color assignment associated with the highest prioritized tag will be applied to the event when the lens is active. For instance, in FIG. 18, an event associated with the “important” tag and the “travel” tag may be represented in orange, e.g., the color assignment associated with the “important” tag.

A user may interact with a calendar settings panel 1820 to control the specific calendars from which events may be displayed, and designate the corresponding color of those displayed events, when a lens is active. In an embodiment, calendar settings panel 1820 may contain a listing of all known calendars associated with a user. Each listed calendar may be associated with a toggle that, when selected, may instruct lens control panel 1805 to display all events that the user plans to attend that are associated with the relevant calendar. For example, because each calendar listed in 1820 has been selected (e.g., as indicated by the active toggles), then all events that the user has indicated they will attend, across all calendar, will be displayed.

In an embodiment, the toggle associated with each calendar may be represented in a color, which may dictate how events associated with that calendar are displayed. The color associated with each toggle may adjusted through interaction with icon 1840. As an example of the foregoing, calendar settings panel 1820 in FIG. 18 contains a “Birthdays” calendar 1845, a “Personal” calendar 1850, a “Family” calendar 1850, a “Golden State Warriors” calendar 1860, and a “Holidays in United States” calendar 1865. The toggles associated with calendars 1845, 1850, 1855, and 1865 are represented by a first color (e.g., blue, as visually represented by a solid circle) whereas the toggle associated with calendar 1860 is represented by a second color (e.g., orange, as represented by an empty circle). This indicates that when the current lens is active, events that the user is attending that are associated with calendars 1845, 1850, 1855, and 1865 may be presented with a blue color whereas events that the user is attending that are associated with calendar 1860 are presented with an orange color. In some aspects, a particular event that the user does not intend to attend (but wants to be aware of) may be promoted to a specific layer of a calendar and may be presented in the same color as other events in that layer that the user plans to attend. In an embodiment, calendar settings panel may include a “show all” toggle 1870 that, when activated, may show all events that the user is planning to attend, regardless of calendar. Color indicator 1875 may represent the color that would be applied to any event that had not already been assigned a color based on a calendar or tag.

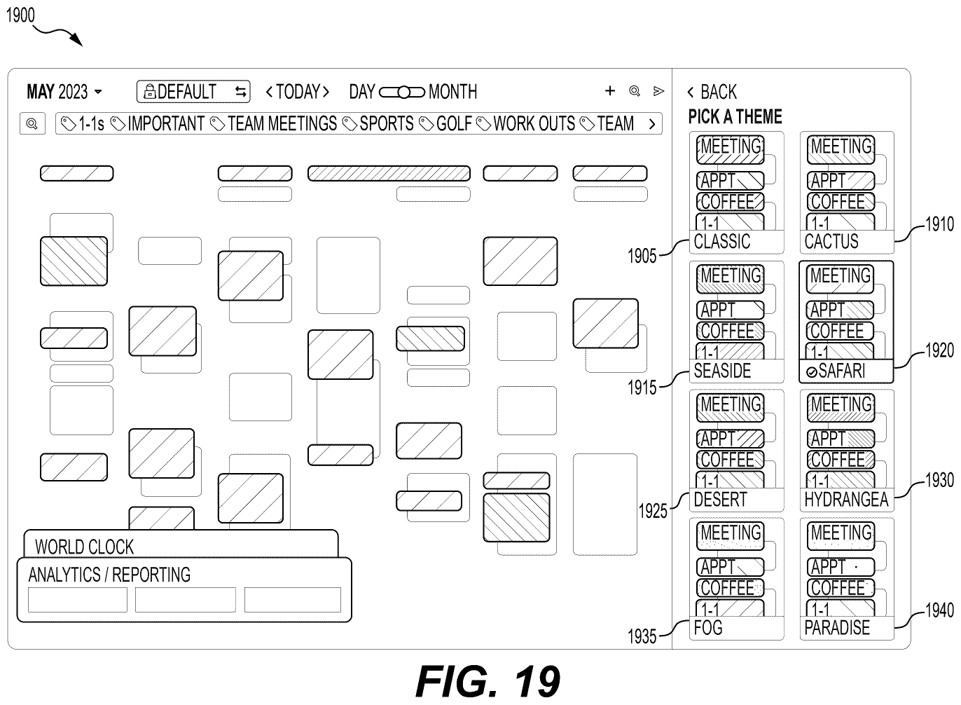

Because choosing a visually appealing color scheme may be difficult to do, users may be able to interact with theme selector 1810 to choose from a multitude of pre-configured themes. For instance, FIG. 19 illustrates calendar 1900 that contains a plurality of different color theme palettes, e.g., “Classic” 1905, “Cactus” 1910, “Seaside” 1915, “Safari” 1920, “Desert” 1925, “Hydrangea” 1930, “Fog” 1935, and “Paradise” 1940. Each color theme palette may have specific designations for how: events associated with certain tags appear, events associated with certain calendars appear, etc. In an embodiment, each color theme palette may have two categories of color: complementary colors and highlight colors. With respect to the former, complementary colors may provide subtle differentiation between events, but blend well together to form an aesthetically appealing calendar. With respect to the latter, highlight colors may provide more of a contrast, thereby visually emphasizing the events the user wants to stand out. Upon selection of a certain color theme palette, e.g., “Safari” 1920, the color assignments for all relevant events will be adjusted to match the color themes in the selected color theme palette. In an embodiment, system 100 may be able to dynamically generate context-based color theme palettes that incorporate colors that are prominently associated with a specific area or region (e.g., city, state, country, etc.). For instance, a user visiting Pittsburgh may be able to select a “Pittsburgh” palette that contains color designations (e.g., black and gold) that are often associated with the sports teams of the region.

Turning now to the concept of “rules,” users may leverage a search functionality associated with the calendaring platform to more easily apply tags to the searched event. More particularly, users may perform a search across all events to identify which events contain certain attributes. System 100 may be configured to then automatically apply one or more tags to each event that contains the targeted attribute(s).

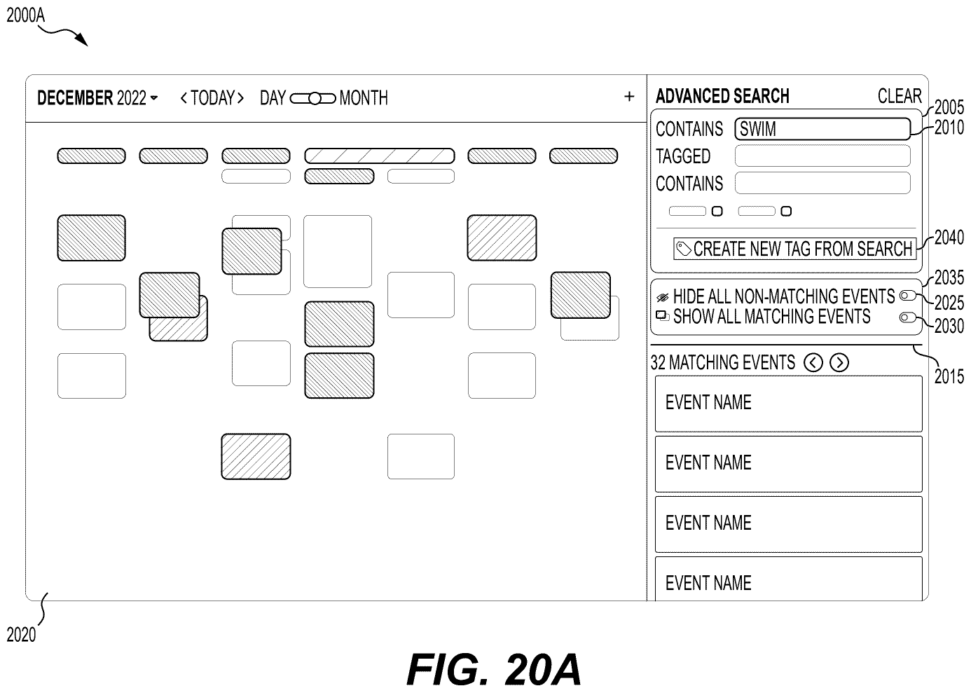

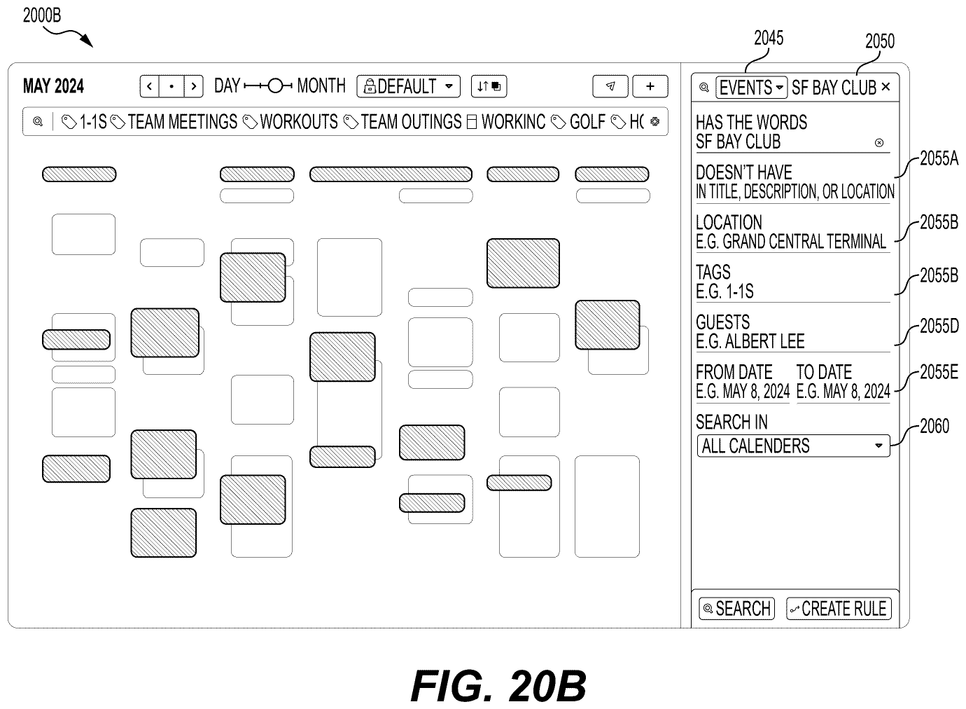

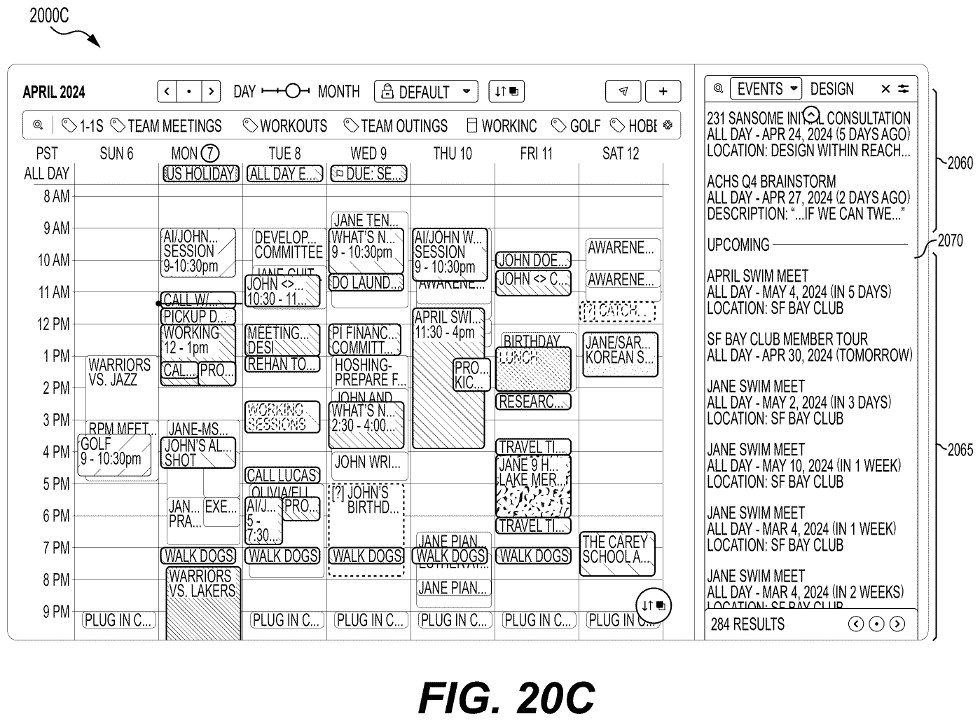

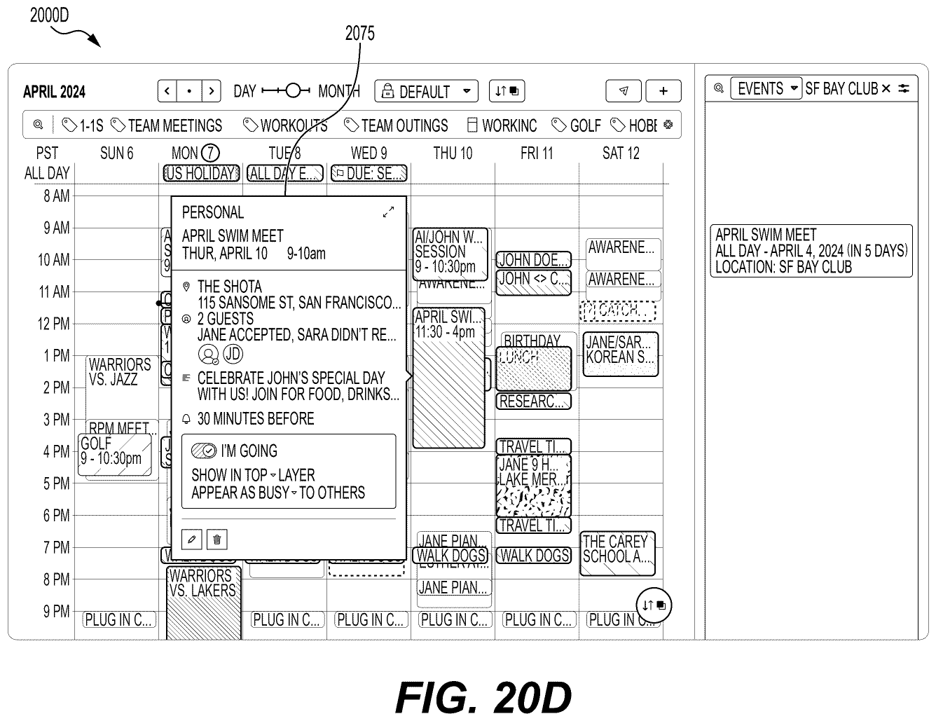

Referring now to FIG. 20A, an exemplary search interface 2000 is presented according to an embodiment. A user may interact with a search panel 2005 to designate one or more criteria that they would like system 100 to search for in their events. For example, a user may type a term into an input field 2010, e.g., “swim,” and system 100 may then search through their events to determine if any event contains the term, “swim.” Any events determined to contain the searched criteria may be listed in results section 2015. In an embodiment, the order of the presented events in results section 2015 may be based on determined relevance (e.g., events determined to more closely match the search criteria may be situated higher on the list of events in results section 2015). Additionally or alternatively, the search results may be visually distinguished on calendar 2020 based on user interactions with toggles 2025 and 2030 in results display panel 2035. More particularly, a user may choose to hide all non-matching events on calendar 2020 by selecting toggle 2025 and/or may choose to visually emphasize all matched events by moving the matched events to the top layer, e.g., by selecting toggle 2030. In an embodiment, a user may add one or more additional tags to any event in the search results by interacting with icon 2040.

It is important to note that the search example provided above represents just one exemplary way that a user may utilize search panel 2005 to search for and add a tag to an event. Users may leverage characteristics of search panel 2005 to perform more granular and/or different kinds of searches. For instance, users may specify the specific fields having user-facing text that they want system 100 to search for the requested criteria in (e.g., in the event name, description, guest list including guest name and/or email address, location, tags, etc.). Additionally or alternatively, users may perform various types of non-string searches, including: events having a specific number of guests, events having guests with a specific email domain, events of a specific duration, events that are or are not repeating, events that have or do not have at least one other tag, and the like. Additionally or alternatively, users may place search restrictions on the search. For instance, a user may instruct system 100 to constrain text searches to a specific field (e.g., event name and location) or to constrain all searches to a specific calendar. Additionally or alternatively, search panel 2005 may be configured to handle various types of Boolean terms, such as “AND” or “OR” statements.

As an example of the foregoing, FIGS. 20B-20C illustrate alternative embodiments of an advanced search interface. Turning first to FIG. 20B, search interface 2000B may enable users to interact with a search toggle 2045 to designate the aspect of the calendaring platform that they want searched (e.g., events, message, contacts, etc.) and provide a search query into an input field 2050 that system 100 will search the designated aspect for. Search interface 2000B may also contain a plurality of other search input fields (e.g., a “Doesn't Have” field 2055A, a “Location” field 2055B, a “Tags” field 2055C, a “Guests” field 2055D, and a date range field 2055E) that users may interact with to further refine their search. Search interface 2000B may further contain a calendar designation toggle 2060 that enables users to designate which specific calendar they want searched.

Upon submitting a search request, search interface 2000C presents an exemplary listing of search results that correspond to the user's search query and their input designations. For instance, search interface 2000C may contain a first set of search results 2060 that correspond to all events that match the search criteria that have already occurred and a second set of search results 2065 that correspond to all upcoming events that match the search criteria. Should a user interact with a specific search result, e.g., search result 2070, then, in some aspects, system 100 may cause a popup window 2075 to be presented on the user interface that provides greater detail about the selected event and that a user may interact with, as illustrated in search interface 2000D of FIG. 20D.

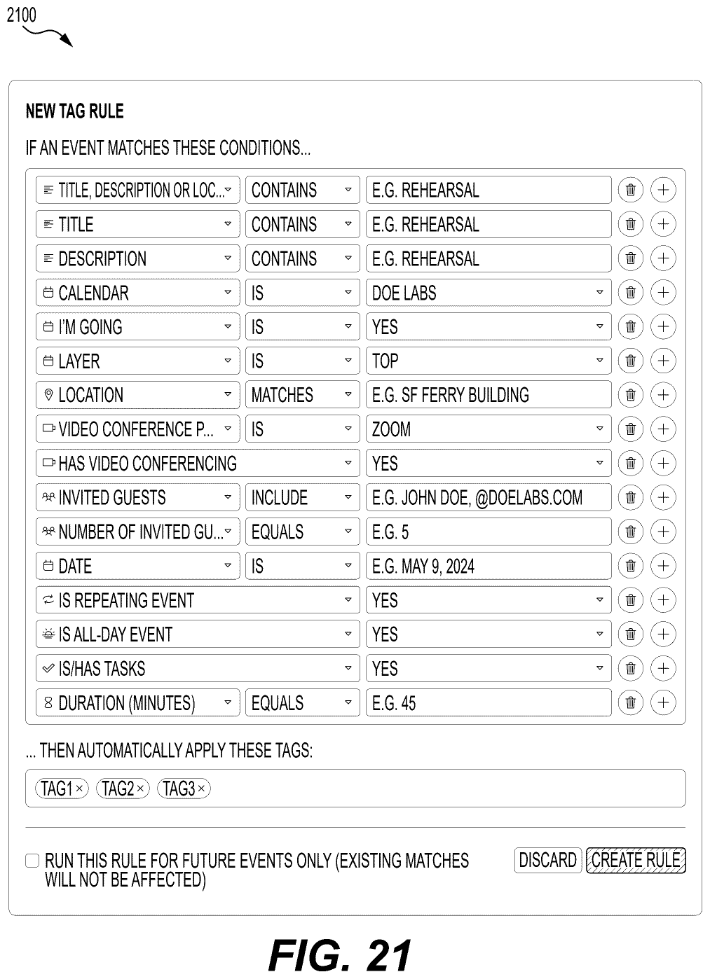

A plurality of non-limiting “rules” use cases for applying a tag to a search results are subsequently listed. In one use case, a tag may be applied to any event that includes a specific term (e.g., “golf,” “Marketing,” etc.) in any field (e.g., subject line, event title, event description, event location, event date, event duration, event attendee list, etc.). In another use case, a tag may be applied to any event that includes a specific term in a specific field (e.g., the term “golf” in the event title). In another use case, a tag (e.g., “1-1”) may be applied to any event with one guest that includes specific attendees. In another use case, a tag may be applied to events with external guests (or all internal guests). In another user case, a tag may be applied to all events that are repeating or non-repeating. In another use case, a tag may be applied to events with a location containing a zip code. In another use case, a tag may be applied to events with a zip code that is greater than a predetermined threshold distance away from the user. In another use case, a tag may be applied to all events where the listed event duration is greater than a threshold set of time. It is important to note that the types of “rules” listed above are non-exhaustive, and a variety of other “rules” may be applied to create a tag. For instance, FIG. 21 presents a variety of different types of rulesets that a user may interact with to control how a system assigns a particular tag to an event.

### Smart Metrics

Understanding how time is utilized is crucial for effective time management. However, traditional digital calendars lack the ability to offer meaningful insights into past time usage, making it challenging for users to reflect on their habits and optimize future schedules. Conventional attempts to address time management challenges have primarily focused on user interfaces, event organization, and task management. While these attempts have provided basic functionality for scheduling and viewing events, they fall short in offering advanced metrics for analyzing time usage patterns. Specifically, existing tools lack the granularity required to provide detailed insights into specific tag-related data, thereby hindering the user's ability to optimize their time effectively.

The concepts described in this section introduce smart metrics that are designed to address the limitations of conventional calendars and that may empower users with advanced insights into their time usage. One feature introduced in this section are “mini-metrics,” which are quick and convenient gauges that provide users with nuggets of information to help them stay on track. Users may customize mini-metrics per view and per lens (as previously discussed in the sections above), thereby allowing for tailored insights based on different contexts. Another feature involves “reporting,” which provides a more robust data analysis functionality that enables users to create visualizations and one-off reports based on a variety of event data. This feature allows for in-depth analysis of various events (e.g., tracking workouts per year by the day of the week, tracking the number of meetings shared with specific individuals, etc.). Tag-specific metrics represent yet another feature, which are utilized to incorporate metrics focused on specific tags, thereby allowing users to analyze how much time is allocated to events associated with a particular tag. Collectively, these metrics provide the user with a comprehensive understanding of past time usage-which they may ultimately leverage to make informed decision-making for future time planning. Additionally or alternatively, in another aspect, the metrics may provide the user with a comprehensive understanding of current planned time for the future as well. For instance, the metrics may inform a user that they only have a limited amount of exercise scheduled for the upcoming week, which may encourage the user to schedule more workout time.

Turning first to mini-metrics, a user may create, select from, and/or customize a specific mini-metric “view” that may provide them with helpful information regarding their time. In this regard, each “view” may consider scheduled events in a particular timeframe (e.g., in a day, a week, a month, a year, etc.) and provide temporal metrics associated with the events in that time frame. Additionally or alternatively, each “view” may be specifically themed and may provide metrics related to that theme. In an embodiment, mini-metrics may be used in association with a “working hours” settings menu that users may interact with to designate the hours of the week that they are working (e.g., those hours that a user is available to attend meetings and/or other work-based events).

In one embodiment, a user may choose to leverage a “Free Time” view that may provide indications of the total unallocated time in the designated view timeframe. In the context of this view, unallocated time may refer to any time within the view timeframe that has not already been designated to a scheduled event. Metrics associated with this view may be represented as minutes or hours available. For instance, given a “Free Time” view for an upcoming week, system 100 may provide the user with an indication that they have “27 free hours” during the upcoming week (wherein the total number of hours in the upcoming work week may be determined in view of a “working hours” setting, as previously discussed). In an embodiment, system 100 may either include or exclude the hours associated with a “non-working” day in its calculations to determine the free hours available for the user.

In another embodiment, a user may choose to leverage a “Focus Time” view that may provide various metrics associated with identified free time within a designated time frame that the user may use to focus on a project or task. In the context of this view, metrics associated with focus time may refer to: the total number of blocks of free time that satisfy certain criteria (e.g., the blocks of free time that are of a predetermined length, such as 60 minutes or more, etc.), the total number of events explicitly containing a “focus” tag and/or the cumulative time associated with “focus” tagged events, or a combination of the foregoing. In an embodiment, system 100 may either include or exclude the hours and/or events associated with a “non-working” day in its calculations to determine the focus metrics for the user in the designated time frame.

In another embodiment, a user may choose to leverage a “Countdown” view that may display the time remaining until the next event that matches a specific tag. For instance, a user may select a tag titled “board meeting” to keep track of all board meeting-related events so that they could be apprised of the number of days until the next board meeting to ensure that they are properly prepared beforehand. In an embodiment, system 100 may be configured to output the countdown data to the user in a variety of different ways. For instance, responsive to identifying that a target event is more than a threshold number of days away (e.g., more than 1 day away), system 100 may display a notification, such as “<days> from today until the next <tag> event.” In another example, responsive to determining that the target event is later in the day, system 100 may display a notification, such as “<hours> until the next <tag> event.” In each of the foregoing cases, the notification may contain additional event information (e.g., event name, event location, event summary, etc.). If there are no future events that match the tag, system 100 may be configured to display a notification, such as “No future events for <tag>.”

In another embodiment, a user may choose to leverage an “Event Count” view that may display the total number of events that match a specific tag. For instance, a user may want to know how many events are tagged as “important.” Responsive to receiving this request, system 100 may generate a notification to the user apprising them of the number of “important” tagged events. Additionally or alternatively, in another embodiment, the notification may also display the total hours for the sum of all matching events.

In another embodiment, a user may choose to leverage a “Total Hours” view that may display the total cumulative hours for events that match a specific tag. For instance, a user may want to know the total number of hours occupied by events that are tagged as “workout.” Responsive to receiving this request, system 100 may generate a notification to the user apprising them of the total hours that “workout” tagged events occupy on the calendar.

### Additional Aspects for Smart Metrics

### Metrics Toolbar

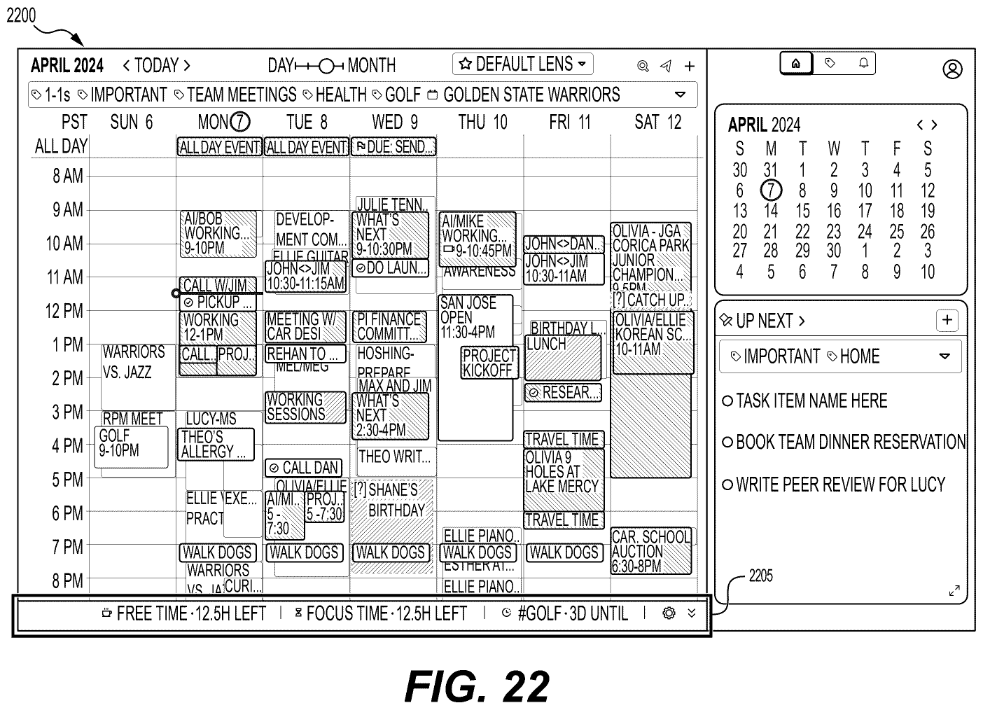

In accordance with aspects described herein, a metrics toolbar may be provided within a calendaring interface for the real-time presentation of dynamic schedule insights. In one embodiment, as shown in user interface 2200 in FIG. 22, the metrics toolbar 2205 may be configured to be positioned along the bottom edge of the calendar canvas, presenting a horizontally-aligned set of metrics, e.g., “Free Time,” “Focus Time,” and “#golf countdown.” In an aspect, the metrics toolbar 2205 may be implemented to be fully responsive, such that its width may dynamically adjust to match the width of the calendar canvas. This may ensure seamless visual integration across various browser sizes and device display dimensions. Conversely, as the display area is expanded, additional metric items may automatically be rendered into view, thereby enabling maximum data visibility without user intervention. In implementations where the number of selected metrics exceeds the horizontal display capacity, a metric overflow indicator (e.g., “+X”) may be presented at the far right of the metrics toolbar 2205. User interaction with this element may cause a floating panel to appear, displaying the additional metrics in a vertically stacked or grid arrangement, each preserving their interactive functionality.

In an aspect, to enhance visual clarity and prevent cognitive overload, the metrics toolbar 2205 may apply generous padding and spacing between individual metric displays. Each metric block (e.g., “Free time—12.5 h left”) may be allocated sufficient horizontal and vertical margin to ensure readability and distinct segmentation. This spacing policy may contribute to a minimalist, uncluttered presentation even when multiple metrics are present. In an aspect, each metrics within the metrics toolbar 2205 may be displayed using a uniform font style, iconography, and spacing schema to promote intuitive visual parsing. Interactive states, such as hover effects or alert badges (e.g., countdown warnings or low focus-time indicators), may modify the appearance of the metric temporarily without disrupting the layout flow.

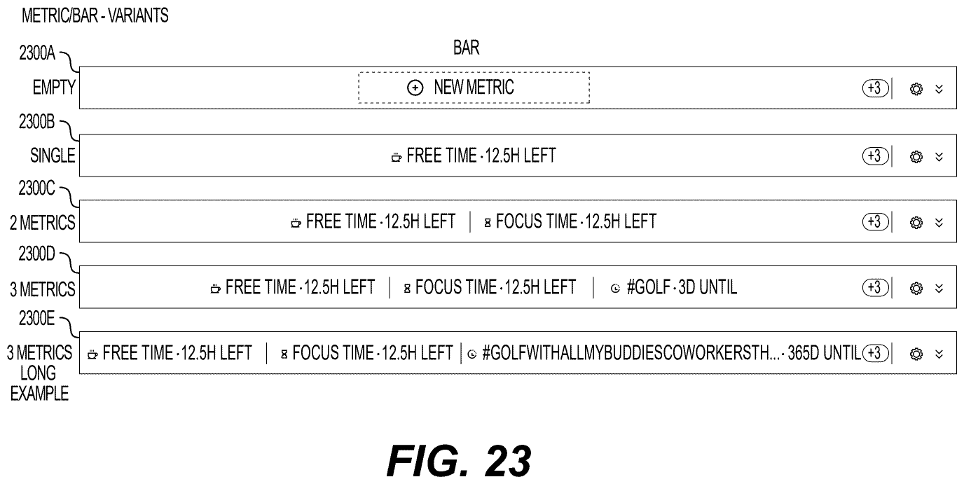

FIG. 23 illustrates non-limiting display variants (e.g., 2300A-2300E) of the metrics toolbar. For instance, metrics toolbar 2300A illustrates a display variant that appears when no metrics have been added yet; only a “New Metric” button may be shown to allow the user to begin configuring metrics. Metrics toolbar 2300B illustrates a single metric in the toolbar, such as “Free time—12.5 hours left,” and leaves the remaining space unoccupied. Metrics toolbar 2300C illustrates two metrics presented side by side—such as “Free time” and “Focus time,” each clearly separated to maintain readability. Metrics toolbar 2300D illustrates displays three metrics in full without truncation, such as “Free time,” “Focus time,” and a countdown metric like “#golf—3 d until.” Metrics toolbar 2300E illustrates that when one of the three displayed metrics includes a long tag name, the system may automatically truncate the text with an ellipsis to preserve the visual integrity of the toolbar 2300E.

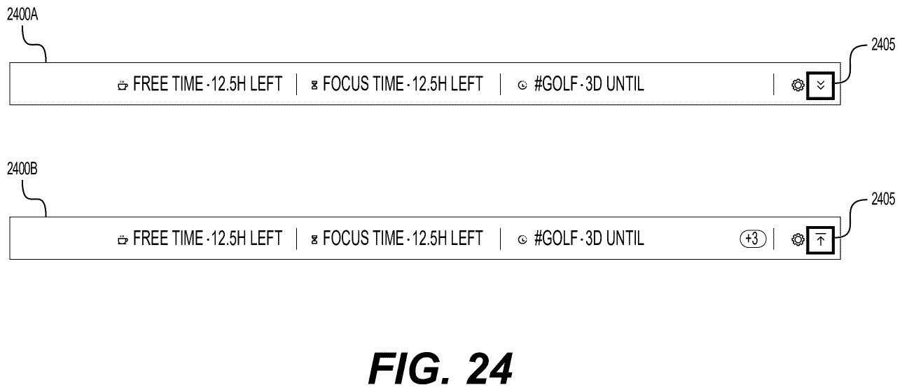

Referring now to FIG. 24, metrics toolbar 2400A may include a toggle control element 2405, positioned at the far right of the toolbar 2400A. The toggle control element 2405 may contain a downward-facing arrow icon, which may allow users to dynamically control the visibility of the toolbar 2400A. In an aspect, in response to a user selecting the toggle control element 2405, the toolbar 2400A may transition into a collapsed or hidden state. Upon activation, the toolbar 2400A may be immediately removed from the visible canvas area, minimizing interface clutter. In an aspect, the system may temporarily deactivate any “open on hover” functionality to prevent inadvertent reappearance. In an aspect, once the user's cursor exits the toolbar's designated hover zone (e.g., typically a defined area near the bottom of the calendar canvas), the open-on-hover behavior may be reactivated. Referring now to FIG. 24B, when the metrics toolbar 2400B is in its collapsed or hidden state, the toggle control element 2405 may transition from a downward-facing arrow to an upward-facing arrow, visually indicating that the toolbar may be restored to the visible state. In response to a user selecting the upward-facing arrow in the toggle control element 2405, the toolbar 2400B may be restored to full visibility and re-anchored to the bottom edge of the calendar canvas. In such an implementation, the toolbar 2400B may remain persistently visible, overriding any temporary hide-on-hover behavior until the user explicitly chooses to hide it again.

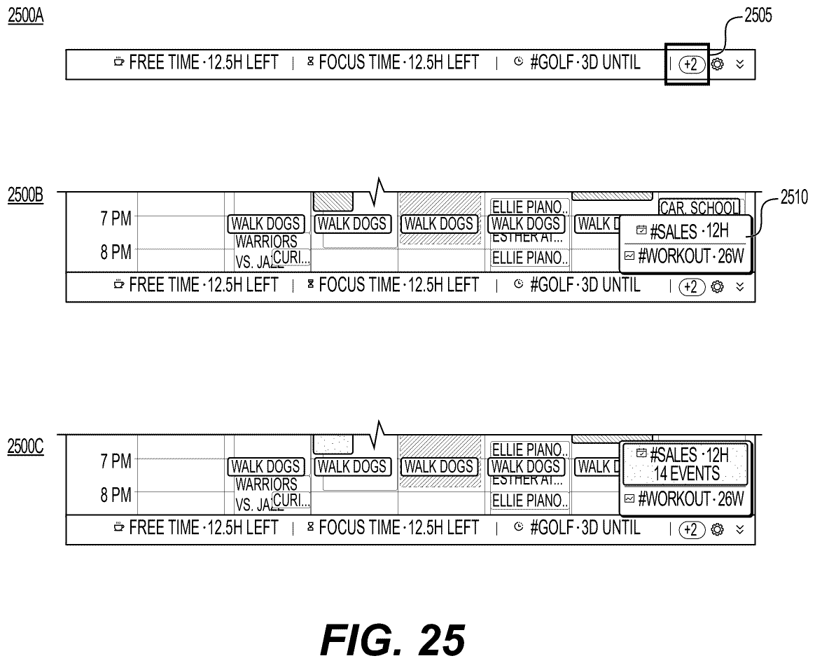

Referring now to FIG. 25, metrics toolbar 2500A may include an overflow indicator element 2505 positioned on the far right side of the toolbar when the number of selected metrics exceeds the displayable width. In an aspect, when the toolbar cannot visually accommodate all selected metrics due to horizontal space limitations, a condensed display element, styled as a bubble and labeled “+X” (where X denotes the number of additional hidden metrics), may be automatically rendered in the toolbar 2500A. This overflow indicator element 2505 may notify the user that one or more metrics are currently not visible in the primary display area. Upon user interaction with the overflow indicator element 2505 (e.g., by clicking, tapping, etc.), the system may display a floating overlay panel anchored near the bubble, e.g., as represented by panel 2510 in metrics toolbar 2500B. This overlay panel 2510 may present the hidden metrics in their standard format, e.g., including text, icons, and interactive functionality (e.g., hover effects, click actions, alert badges). In an aspect, overlay panel 2510 may remain open until manually dismissed, such as by clicking the bubble a second time. In an aspect, metrics within the overlay panel 2510 may behave identically to their counterparts in the primary bar, enabling consistent interaction regardless of placement, as shown in metrics toolbar 2500C.

In aspects where the metrics toolbar 2500A is placed in a collapsed or hidden mode, overflow metrics may not be rendered or may not be accessible until the user initiates an intent-based interaction, e.g., such as hovering over the designated toolbar hover area. Once this area is engaged, the metrics toolbar 2500A, along with any overflow indicators or metrics, may be restored to view, thereby allowing the user to access the full set of metrics temporarily. In an aspect, to preserve the readability and utility of overflow metrics, each metric in the overflow panel may be configured to dynamically expand its width to fully accommodate its text content, including the metric name and description. The system may allocate as much horizontal space as necessary within the limits of the calendar canvas. In an aspect, if a metric's text length exceeds the maximum allowable width of the calendar canvas, the system may initiate intelligent truncation, e.g., using ellipses. In an aspect, truncation may be applied first to the metric name, and then to the metric description only if further reduction is required. This ensures that the most informative portion of each metric remains visible while maintaining layout integrity.

In accordance with aspects disclosed herein, the system may initiate a set of default metrics in the metrics toolbar for each user account. These default metrics may be preconfigured to offer immediate insight into key scheduling dimensions, and may be automatically provisioned without requiring manual setup by the user. In an aspect, one default metric may be a focus time indicator, which may calculate the cumulative duration of available or designated focus intervals within a defined calendar view (e.g., a day, week, or month). This metric may be configured with a default minimum duration threshold of 60 minutes, such that only time blocks meeting or exceeding this threshold may be considered valid “focus time” for calculation purposes. Another default metric may be a countdown timer that tracks the number of days remaining until the next scheduled event tagged with “important.” In an aspect, the “important” tag may be automatically created and pre-associated with each user account during onboarding or account initialization. Another default metric may track the event count for all events tagging with “meeting.” In an aspect, the system may automatically provision the “meeting” tag as a global default tag for each user. In an aspect, the metric may display both the number of meeting events within the selected calendar view and, additionally or alternatively, the total cumulative duration of those events.

### Individual Metrics

Each metric displayed in the metrics toolbar may be governed by formatting and behavior rules tailored to the nature of the metric type. This section outlines the presentation logic for Free Time, Focus Time, Countdown, Time Since, Event Count, and Streak metrics to ensure clarity, consistency, and intuitive user comprehension.

The Free Time and Focus Time metrics may reflect the total quantity of unallocated or designated time within the user's working schedule, based on the current calendar view (e.g., day, week, or month). In an aspect, the time format of these metrics may be displayed in whole hours and minutes (e.g., 9 h, 10 m, etc.). To maintain clarity, all time values may be rounded up to the nearest five-minute increment. Fractional hour formats (e.g., 9.2 h) may be expressly avoided. In an aspect, when the user views a past calendar window, the suffix “left” may be removed from the metric label. For example, “Free Time—1 h 5 m” may be shown instead of “1 h 5 m left” when referring to a completed week. In an aspect, if a commitment event (e.g., an “I'm Going” event) overlaps with an event tagged as Free Time or Focus Time, that tagged event may be excluded from the metric's time calculation. If the overlapping commitment is later removed or converted to an awareness event, the system may automatically recalculate the metric to re-include the previously excluded tagged event.

The Countdown and Time Since metrics may quantify temporal proximity to (or distance from) events associated with a particular tag. In an aspect, all time intervals may be displayed as whole-day values only. Fractional durations such as “9.50 d until” or “1.54 d since” may not be used. Instead, durations may be displayed as, for example, “9 d until” or “2 d since.” In an aspect, the day difference may be computed by subtracting calendar dates only, ignoring time-of-day precision. For instance, if the current date is April 15 and the next tagged event is on April 16, the metric will display “1 d until” regardless of the time of day. In an aspect, when the tagged event occurs on the current day, the metric may display the keyword “Today” in lieu of “0 days.” For example, the Countdown metric may display “important-Today.”

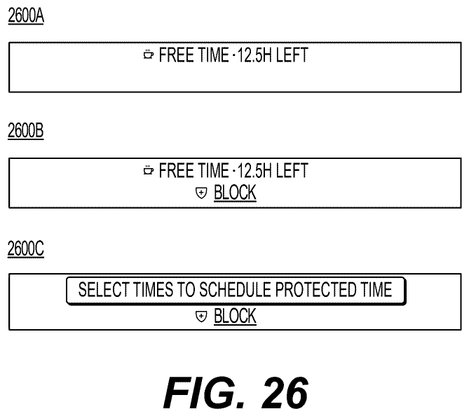

As shown in FIG. 26, the Free Time metric 2600A may be a core element of the metrics toolbar that provides a real-time calculation of unallocated time within the user's calendar. Specifically, the Free Time metric 2600A may represent the total unallocated time available in the current calendar view, constrained by the user's designated working days and working hours. It enables users to quickly access their scheduling flexibility for the selected timeframe (e.g., day, week, or month). In an aspect, the Free Time value may be calculated by subtracting all scheduled commitment events from the total span of configured working hours. All-day day events may be explicitly excluded from the Free Time calculations, regardless of whether they are tagged with a Free Time label, or other applicable labels. In its default or resting state, the Free Time metric 2600A may display a textual label (e.g., “Free Time”) accompanied by a visual icon (e.g., a coffee cup) and the calculated time value remaining within the current view.

In other aspects, the Free Time metric 2600A may support interactive states such as hover overlays for time blocking suggestions or pressed states to trigger calendar updates. For instance, as shown in Free Time metric 2600B, when a user hovers their cursor over the Free Time metric, the system may transition the metric into a hover state to indicate interactivity and expose additional planning functionality. In the hover state, the background color of the metric may be updated to a distinct hover-state shade, visually distinguishing it from its resting state and reinforcing its status as an actionable element. Additionally or alternatively, in an aspect, the text label and icon may be vertically shifted upward within the component's bounding box. Additionally or alternatively, a secondary control element, e.g., labeled “Block” in 2600B, may be revealed beneath the metric text. The Block option may appear as a clickable link accompanied by a shield icon with a plus symbol, indicating that the user may proactively convert available free time into protected calendar blocks. In an aspect, if the user leaves their mouse over the “Block” option, the system may display a tooltip which says “Select times to schedule protected time,” as presented in Free Time metric 2600C. In an aspect, the tooltip may be rounded rectangular element that overlays directly above or near the Block control. Additionally or alternatively, the tooltip may appear only after a short delay or sustained hover to distinguish intentional interaction from incidental cursor movement. The tooltip may disappear when the user moves the cursory away from the Block link or initiates a click on the secondary control element.

In an aspect, the free time metric may dynamically adapt its value and interactivity based on the active calendar view selected by the user. This responsive behavior may ensure that the metric reflects the relevant subset of time for accurate planning and insight. In an aspect, when the user selects Day View, the Free Time metric may display the total unallocated time for the current visible day, provided that the day is within the user's configured working days. If the selected day is excluded from the configured working schedule (e.g., weekends or custom blackout dates), the system may display the text “N/A” in place of a time value. In an aspect, in Week View, the Free Time metric may calculate the aggregate total of free time across all working days included in the user's configuration for that week. This may allow the user to assess overall availability during the upcoming work week. In an aspect, Free Time and Focus Time metrics may not be applicable in Weekend View. Rather, the metric may display a non-interactive placeholder, e.g., “N/A.” If the user hovers over the Free Time metric while in Weekend View, instead of revealing a “Block” option, the system may render a static, plain-text message stating: “Not available in Weekend View.” This message may not be hyperlinked or actionable, and may serve solely as an informative notice. In an aspect, in Month View, the Free Time metric may display the cumulative total of all unallocated time across working days in the entire calendar month currently in view, e.g., as defined by the month header (e.g., April 2024), regardless of whether all dates are fully visible in the canvas. This may ensure consistency with other view-dependent metrics and may provide a reliable reference for long-range planning. In an aspect, to ensure accurate representation of available time, the system may account for special scheduling conditions when calculating the Free Time metric. For instance, in certain circumstances, a user's calendar may contain invited events to which the user has either not responded or has marked with a tentative status (e.g., “Maybe”). These events may be excluded from being treated as confirmed time commitments and may not be subtracted from the user's available time.

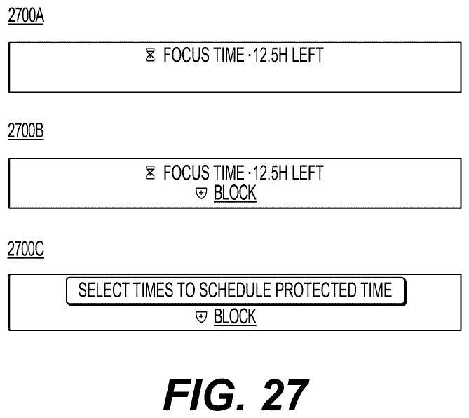

As illustrated in FIG. 27, the Focus Time metric 2700A may provide users with a real-time visualization of concentrated, uninterrupted working time within the configured calendar view. This metric may be designed to help users plan and protect cognitively demanding work blocks. In an aspect, the Focus Time metric 2700A may calculate the total amount of “focus time” available or scheduled within the current view (e.g., day, week, or month), constrained by the user's designated working days and hours. In an aspect, Focus Time may be derived from one or both of the following user-configurable sources: unallocated time blocks that meet or exceed a minimum length threshold (e.g., by default this threshold may be set to 60 minutes, but may be adjustable by the user), and scheduled events tagged with “focus,” with the option to customize or add additional tags for inclusion in the calculation. The system may treat these sources as additive: time blocks qualifying under either rule contribute to the cumulative Focus Time total. In an aspect, all-day events may categorically be excluded form the Focus Time calculation, even if explicitly tagged as “focus time.”

In its default state, the Focus Time metric 2700A may display the time remaining in the selected calendar view using whole-hour formatting (e.g., “12.5 h left”), accompanied by a stylized hourglass icon. The Focus Time metric 2700A may remain visually unobtrusive until hovered over or interacted with. As shown in Focus Time metric 2700B, when a user hovers their cursor over the Focus Time metric in the metrics toolbar, the Focus Time metric 2700B may enter a hover state, characterized by a subtle background color change to visually indicate interactivity. A secondary control element labeled “Block” may appear beneath the time value, featuring an icon (e.g., shield with a plus sign) and a hyperlink-style label. If the user's cursor remains over the metric or the “Block” link, a tooltip may be rendered, providing instructional text, e.g., “Select times to schedule protected time,” as shown in Focus Time metric 2700C. In an aspect, the tooltip may be positioned in proximity to the “Block” link and may be styled to facilitate visual clarity, e.g., styled with dark background and white text for accessibility. The tooltip may disappear upon cursor exit from the hover region or once the user initiates an action.

In an aspect, upon clicking the “Block” link, the Focus Time metric may transition into a pressed state, e.g., as shown by Focus time metric 2700B. In this state, the background color of the entire Focus Time metric may change to indicate active engagement. The system may trigger navigation to the Time Blocking feature, thereby allowing the user to interactively select and schedule focus time blocks directly on the calendar canvas. In this state, the system may suppress other hover behaviors temporarily to allow focused interaction with the time selection workflow.

In an aspect, the Focus Time metric 2700A may dynamically adapt its calculation and display output based on the active calendar view selected by the user. This behavior may ensure that the Focus Time metric 2700A reflects only the relevant portion of scheduled or available focus time, consistent with user-configured working days and hours. In an aspect, when the user selects Day View, the Focus Time metric may display the total available or scheduled focus time for the currently visible day, provided that the day falls within the user's configured working days. If the day is excluded from the configuration (e.g., a weekend or a custom non-working day), the system may display “N/A” to indicate that focus time is not applicable for that date. In an aspect, in Week View, the system may calculate and display the aggregate focus time across all included working days within the selected week. Both unallocated blocks meeting the minimum threshold and appropriately tagged events may be included in this total. In an aspect, the Focus Time metric 2700A may not be supported in Weekend View. Rather, in this view, the Focus Time metric 2700A may display “N/A,” signaling that focus time does not apply to the currently visible timeframe. If the user hovers over the Focus Time metric 2700A while in Weekend View, the interface may display a non-interactive message, e.g., “Not available in Weekend View.” This message may be presented as plain text and may not be hyperlinked or actionable. In an aspect, when Month View is active, the Focus Time metric 2700A may display the cumulative total of all qualifying focus time across working days within the calendar month currently shown in the header (e.g., “April 2024”). This total may be calculated regardless of whether all days in the month are fully visible in the viewport, ensuring consistency with other monthly planning tools.

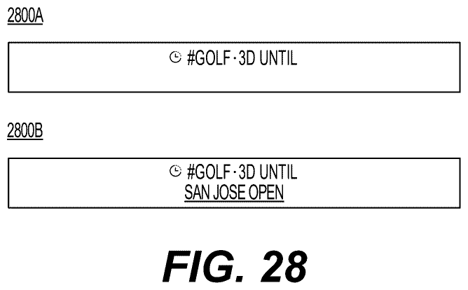

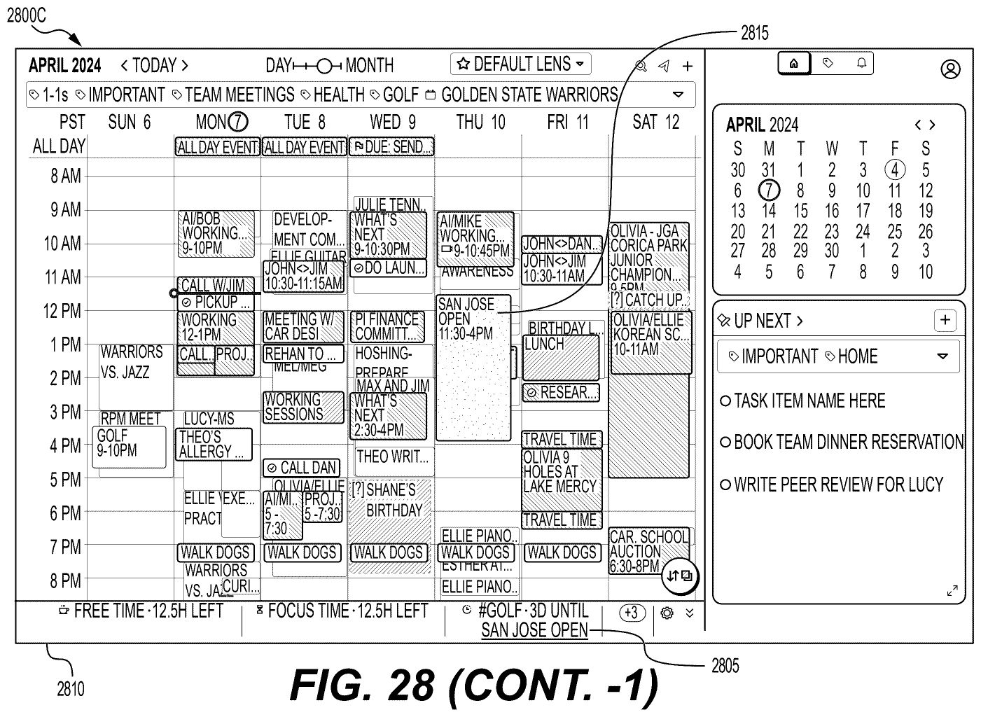

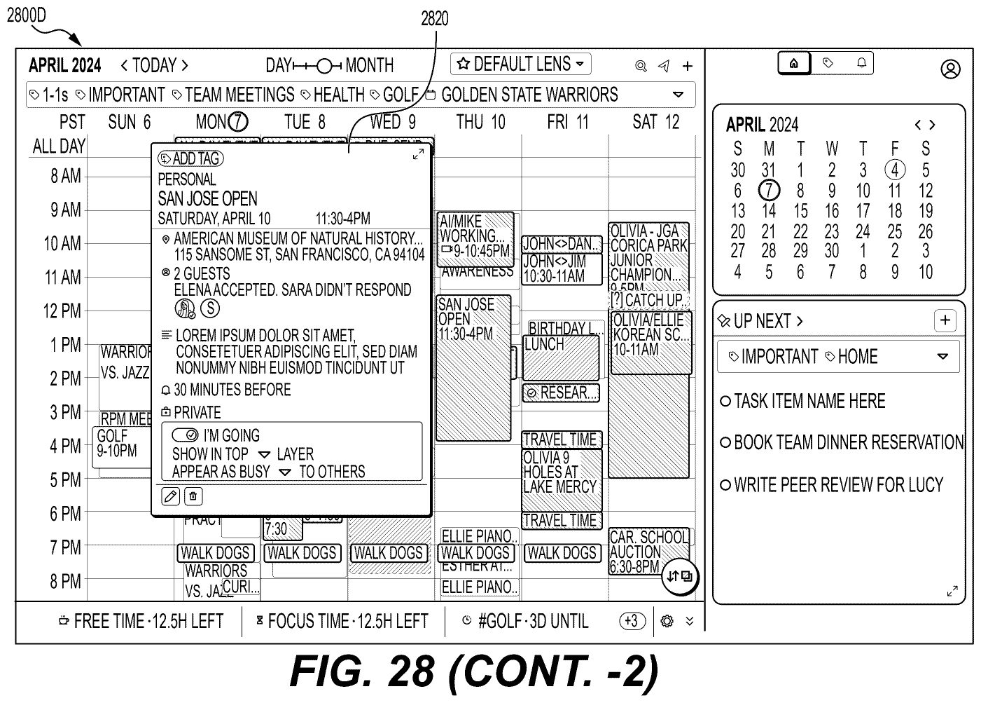

As illustrated in FIG. 28A, the Countdown metric 2800a may be a user-configurable time-based indicator within the metrics toolbar that displays the number of days remaining until the next upcoming event associated with a selected tag. The Countdown metric 2800A may allow users to track the proximity of key upcoming events by associating the metric with a specific event tag (e.g., “golf,” “board meeting,” “project deadline,” etc.). The system may calculate the number of full calendar days remaining until the next event that matches the specified tag name. This functionality may enable users to remain proactively aware of important deadlines, milestones, or recurring meetings and may allow them to prepare accordingly. In an aspect, time may be shown in whole-day increments using a compact, human-readable format (e.g., “3 d until”), omitting any fractional days (e.g., “1.5 d until”). In an aspect, the day difference may be computed based on calendar dates only, independent of specific event times. For instance, if today is April 15 and the event occurs on April 18, the metric 2800A may display “3 d until.” In an aspect, if the target event occurs on the current date, the metric 2800 may display “Today” instead of “Od until.”

In its default rendering, the Countdown metric 2800A may display: a tag-specific label (e.g., “#golf”), a countdown value indicating the number of days remaining (e.g., “3 d until”), and a visual icon (e.g., a clock, stopwatch, etc.) to represent the temporal nature of the metric. This baseline presentation may keep the user aware of critical upcoming items at a glance and serves as a passive planning cue within the broader productivity interface. As shown in Countdown Metric 2800B, when the user hovers over the Countdown metric 2800A, the component may transition into a hover state that reveals contextual information about the target event. In this state, the metric background may change to a highlighted or shaded color to signal interactivity. A secondary label may be displayed beneath the tag and time value, showing the title of the next matching event associated with the configured tag. For example, when the Countdown metric 2800B is configured to track “#golf,” the hover state may reveal the event title: “San Jose Open.” This title may be rendered as a clickable, underlined hyperlink, wherein the font and color styling visually distinguishes the event title from the static countdown information above. This feature may allow users to preview the upcoming event without navigating away from the current view, supporting quick recognition and streamlined access to relevant calendar details.

In an aspect, with reference to interface 2800C, when the user hovers over a Countdown metric 2805 in the metrics toolbar 2810 and the next matching event 2815 is visible in the current calendar view, the system may temporarily highlight the corresponding calendar event. In this hover state, the event associated with the tracked tag (e.g., “#golf”) may be visually emphasized using a distinct fill color or outline (e.g., a solid red background, as with the “San Joe Open” event). This visual effect may differentiate the tagged event from surrounding calendar entries, aiding in rapid identification without the need for scrolling or additional clicks. In an aspect, the highlight may be rendered only if the event is within the visible viewport of the calendar canvas. Once the user moves the cursor away from the Countdown metric 2805, the highlighted event may revert to its original styling, restoring the default visual state of the calendar.

In an aspect, when the user clicks on the linked event title within the Countdown metric 2800B (e.g., “San Jose Open”), the component may enter a pressed state that initiates a direct interaction with the corresponding calendar event. In an aspect, upon activation, the Countdown metric 2800B may transition to a pressed visual treatment, including a subtle background highlight to signal that the element has been clicked. This linked event title (e.g., “San Jose Open”) may remain visible and underlined, but may also adopt pressed-state styling (e.g., darker color or bold underline) depending on implementation. In an aspect, this state may trigger navigation behavior, repositioning the calendar canvas to center the associated event, even if it exists outside the current viewport. In an aspect, the system may retain the user's active calendar view type, e.g., if the user is in Week View, the canvas may scroll forward to the target week; if in Day View, the canvas may advance to the relevant day. In an aspect, once the event is in view, the system may display an event popover, e.g., as illustrated in interface 2800D. In an aspect, the popover 2820 may appear anchored to the event block and may provide full event details, such as title, date/time, location guest list, notes, and RSVP status. In an aspect, the popover 2820 may allow users to review or interact with the event (e.g., edit, RSVP, or access navigation links) without altering the view context. This functionality may provide a streamlined, non-disruptive transition from metric awareness to event-level interaction, enhancing continuity and planning efficiency.

In an aspect, unlike other time-based metrics that dynamically recalculate based on the user's active calendar view, the Countdown metric 2800A may remain static and does not change in response to the selected view mode. Regardless of whether the user is in Day View, Week View, Weekend View, or Month View, the Countdown metric 2800A may display the same remaining time value (e.g., “3 d until”), based solely on the system date and the date of the next matching tagged event. This design ensures temporal consistency and minimizes cognitive overhead by providing a fixed reference to an upcoming event, independent of layout or scope. In an aspect, if there are no future events associated with the selected tag, the Countdown metric 2800A may display “None” as the countdown value. In such cases, an informational message may be shown below the metric for added clarity, such as “No upcoming #golf events.” In an aspect, if the configured tag name exceeds a defined length threshold, the metric display may automatically truncate the tag name to preserve layout integrity.

Truncation may be applied, for instance, using an ellipsis (e.g., “#golftournamentwithcolleag . . . ”). In an aspect, when the next matching event occurs far in the future, resulting in a large numerical countdown (e.g., more than 365 days), the system may apply one or more of the following formatting strategies to accommodate the extended value: font reduction (e.g., shrink the size of the countdown text to fit within the metric's default bounds), scrolling behavior (e.g., enable horizontal scroll within the metric display area), abbreviation (e.g., compress the time using a year-day format, such as “2 y 320 d from today”), and auto-expansion (e.g., dynamically expand the metric width to accommodate long values).

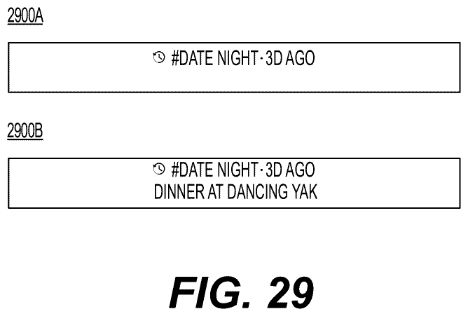

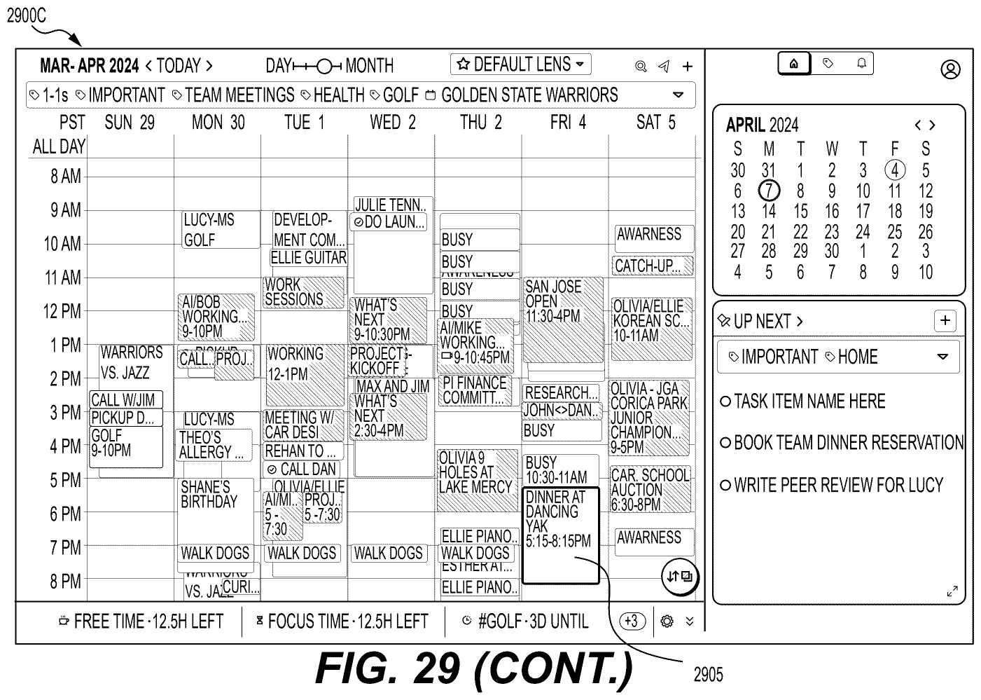

As illustrated in FIG. 29, the Time Since metric 2900A may be a retrospective time-based indicator within the metrics toolbar. The Time Since metric 2900A may display the number of days that have elapsed since the most recent past occurrence of a user-specified tagged event. Functionally the inverse of the Countdown Metric 2800A, the Time Since metric 2900A may enable users to monitor how much time has passed since a previous event occurred that matches a selected tag. For example, a user may configure a Time Since metric 2900A to track the number of days since their last #carservice, #checkup, or #datenight. The Time Since metric 2900A may help reinforce recurring habits, routines, or compliance events that require awareness of time intervals. In an aspect, the Time Since metric 2900A may display time in whole-day increments using the format: “Xd ago,” where X represents the number of full days elapsed since the last matching event (e.g., “3 d ago”). In an aspect, the day difference may be computed using calendar dates only, without regard to the time of day (e.g., if today is April 15 and the last matching event occurred on April 12, the Time Since metric 2900 may display “3 d ago”).

In an aspect, in its default state, the Time Since metric 2900A may present: the tag name (e.g., “#datenight”), the number of days since the last occurrence (e.g., “3 d ago”), and an icon indicating historical measurement (e.g., a clock with a backward arrow). When the user hovers over the Time Since metric 2900A, the component may enter a hover state that may enhance visibility and context by revealing the title of the most recent tagged event, as illustrated by Time Since metric 2900B. In an aspect, the background color of the Time Since metric 2900A may transition to a hover-state treatment, typically using a subtle shading to indicate interactivity. In an aspect, a secondary line of text may appear beneath the main tag and time value, displaying the event title of the last matched occurrence. For example, if the tag is “#datenight,” the hover state may reveal: “Dinner at Dancing Yak.” In an aspect, the event title may be displayed in plain text, non-interactive by default, but may be visually distinct to ensure clear association with the Time Since metric 2900B. This hover behavior enables users to recall specific past events at a glance without requiring navigation to the calendar canvas, improving retrospective awareness and enabling habit tracking or review workflows.

In an aspect, when the user clicks on the event title displayed in the hover state of the Time Space metric 2900B, the component may transition into a pressed state and may initiate event-focused navigation within the calendar interface. Upon activation, the system may scroll or jump the calendar canvas to reveal the most recent occurrence of the event tagged with the selected label (e.g., “#datenight”). The user's current calendar view (e.g., Day View or Week View) may be preserved, and the canvas may be repositioned accordingly to show the relevant date in the appropriate format. In an aspect, the target event (e.g., “Dinner at the Dancing Yak”) may be visually highlighted using a temporary styling treatment, such as an accent-colored background or border, to draw the user's attention to its location on the timeline. The rest of the interface may remain unchanged, allowing the user to continue browsing, editing, or inspecting the calendar around the selected event without disrupting their session flow.

As shown in user interface 29000, when the user clicks the title of a previously matched event in the Time Since metric 2900B, the system may execute a pressed-state transition that navigates the calendar to the location of the most recent tagged event 2905. In an aspect, the calendar canvas may scroll backwards in time, if necessary, to bring the event into view. The user may remain in their current calendar view mode throughout the interaction. If the user is in Week View, the canvas may advance to the appropriate week containing the target event. If the user is in Day View, the system may navigate to the specific day of the event. If the user is in Month View, the canvas may scroll to display the relevant month. In an aspect, upon arrival at the corresponding event, the system may perform the following actions: the calendar event block (e.g., “Dinner at Dancing Yak”) may be temporarily highlighted using a visually distinct treatment (e.g., orange fill) to draw attention; a detailed event popover may be displayed, presenting the event's metadata (e.g., title, time, location, guest status, notes, and RSVP controls); and this popover may allow the user to inspect or interact with the event without altering the calendar view state. In an aspect, after a fixed interval (e.g., two seconds, etc.), the aforementioned highlight may be automatically removed. This delayed fade-back behavior may ensure the highlight is sufficiently visible to orient the user but non-disruptive to the broader visual layout. In an aspect, when the Time Since metric refers to an all-day event, the system may perform a modified time calculation. For instance, the difference in days may be computed from the current time to midnight of the day the all-day event concluded, ensuring the metric accurately reflects time elapsed since the effective end of the event. This normalization may guarantee consistency across time zones and avoid ambiguity due to the lack of start/end time granularity in all-day events.

In an aspect, regardless of whether the user is in Day View, Week View, Weekend View, or Month View, the Time Since metric may display a constant value reflecting the number of days that have passed since the most recent tagged event. In an aspect, if no event tagged with the selected label exists in the past, the Time Since metric may display “None” in place of a time value. To provide contextual clarity, a sub-label may be displayed beneath the tag, such as: “No previous #golf events.” In an aspect, when a selected tag name exceeds a defined character threshold, the metric interface may automatically truncate the tag name, using ellipses to indicate abbreviation (e.g., “#golfoutingwithfriends . . . ”). If the most recent tagged event occurred a very long time ago, resulting in a large number of elapsed days, the system may apply one or more formatting strategies to preserve visual readability and interface balance: font reduction (e.g., shrink the size of the time value text to fit within the metric's default bounds), scrolling behavior (e.g., enable horizontal scroll within the metric display area), abbreviation (e.g., compress the time using a year-day format, such as “2 y 320 d from today”), and auto-expansion (e.g., dynamically expand the metric width to accommodate long values).

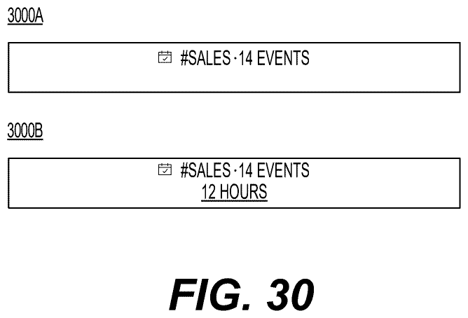

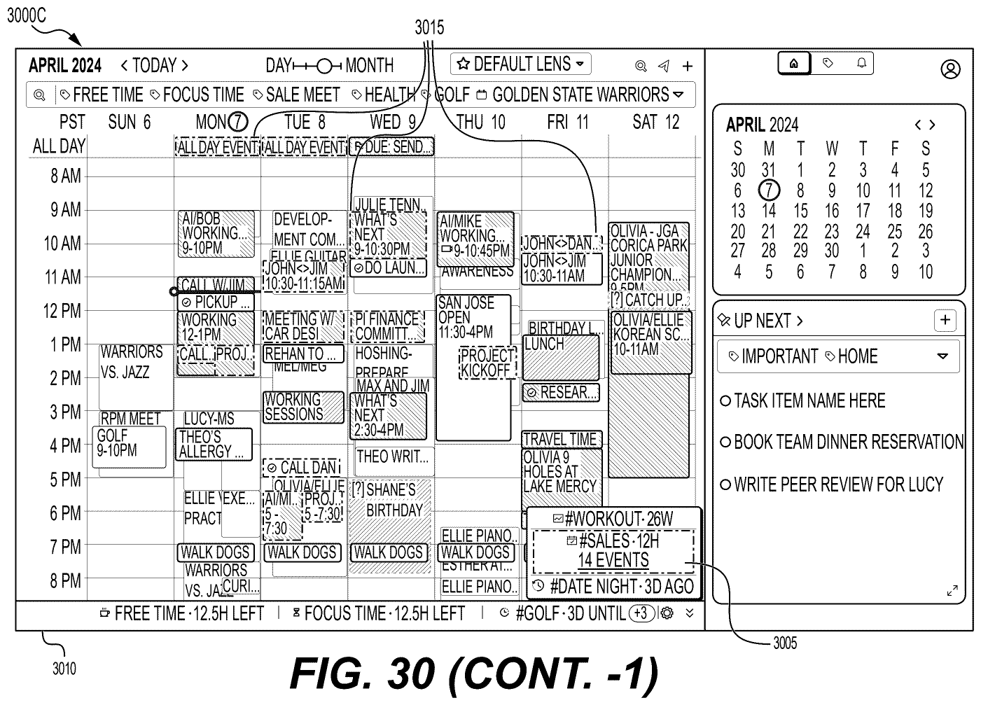

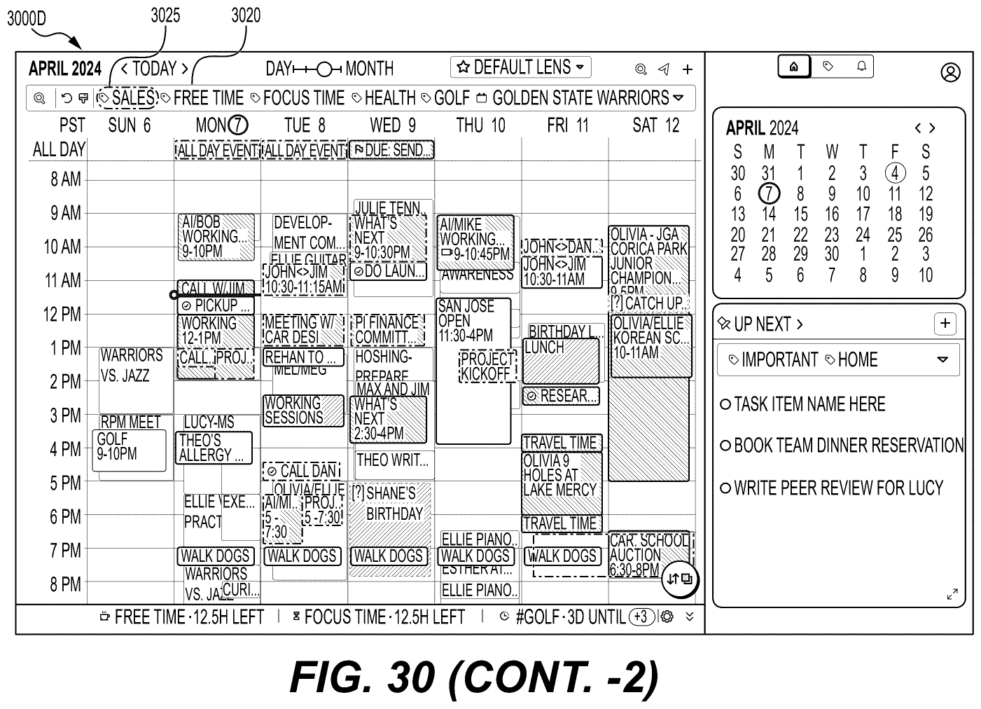

As shown in FIG. 30, the Event Count metric 3000A may allow users to track scheduling volume by counting calendar events that share a specified tag (e.g., #sales, #1on1, #training). The Event Count metric 3000A may differ from other time-based metrics in that it offers dual primary display modes, one of which is the Number of Tagged Events. In an aspect, when configured to display the Number of Tagged Events as the primary metric, the Event Count component shows: a tag-specific label (e.g., #sales), a numerical count of how many tagged events exist within the current calendar view, displayed in the format: “14 events.” This count may include all calendar events that match the specified tag, regardless of duration. In an aspect, all-day event may be included in the event count, ensuring a complete tally of relevant calendar items. Events that span multiple days may be counted once per event, not per day. In its default state, the Event Count metric 3000A may display: a calendar icon, the tag name (e.g., “#sales”), the total number of events (e.g., “14 events”). This display may allow users to quickly assess how many times a particular meeting type, project touchpoint, or thematic event appears in the current timeframe-whether for load balancing, trend analysis, or operational review. When the user hovers over the Event Count metric 3000A, the component may enter a hover state that reveals the total cumulative hours of the tagged events within the current view, as shown in Event Count metric 3000B. In this regard, a secondary line of text may appear below the primary event count, showing the sum of the durations of all matching tagged events within the current calendar view (e.g., “12 hours”). This hover interaction may allow users to gain deeper insight into not just the volume but also the temporal weight of the specific event categories, aiding in time management and calendar optimization.

Turning now to user interface 3000C, when the user hovers over an Event Count metric 3005 within the metric toolbar 3010, the system may enter a hover-highlight mode that visually emphasizes all events 3015 in the current calendar view associated with the specified tag. For example, if the metric tracks the “#sales” tag, every event in the visible calendar tagged with “#sales” may be highlighted using the same color treatment that would appear if the tag were manually selected in the Tag Bar. This behavior may allow users to quickly visualize the distribution and clustering of thematically tagged events across the calendar canvas, enhancing spatial awareness and workload assessment.

In an aspect, when the user clicks on an Event Count metric 3000A, the component may transition into a pressed state (e.g., as shown by Event Count metric 3000B) that signals active engagement and anchors the interaction in the user interface. In an aspect, the pressed metric may remain in its active state until the user either: deselects the metric (e.g., via clicking elsewhere or toggling interaction), navigates away from the current view, or selects a different metric that overrides the current interaction. As depicted in user interface 3000D, clicking on the Event count metric 3000B not only changes the metric to its pressed state, but also initiates synchronization with the tag bar 3020, reinforcing visual and functional cohesion between the metrics toolbar and tag-based filtering. In an aspect, upon activation, the system may automatically select the corresponding tag 3025 (e.g., “#sales”) in the tag bar 3020 located above the calendar canvas. All events matching the selected tag within the current view may be persistently highlighted, using the tag's defined highlight color (e.g., yellow). In an aspect, the system may maintain this state until the user manually deselects the tag 3025 from the tag bar 3020.

In an aspect, the Event Count metric 3000A may dynamically adapt its calculation based on the user's currently selected calendar view. This may ensure that the displayed value remains relevant to the visible timeframe and context. In an aspect, when the calendar is set to Day View, the Event Count metric 3000A may display the number of events tagged with the specified label (e.g., #sales) that occurs on the currently visible day. If no matching events are present on that day, the Event Count metric 3000A may display “None.” In an aspect, in Week View, the system may calculate the total number of matching tagged events that fall within the entire 7-day week currently displayed. If no such events are found, the Event Count metric 3000A may display “None.” In an aspect, when in Weekend View, the Event Count metric 3000A may display the count of events matching the tag that fall on Saturday and Sunday of the selected weekend range. If no matching events are scheduled over the weekend, the Event Count metric 3000A may display “None.” In an aspect, in Month View, the Event Count metric 3000A may reflect the number of matching tagged events occurring within the entire calendar month indicated in the header (e.g., “April 2024”), regardless of whether all days of that month are fully visible in the canvas. In an aspect, if there are no events in the current calendar view that match the selected tag, the Event Count metric 3000A may display “None” as the primary line and “No events” in the secondary line (if present). In an aspect, when the selected tag name exceeds layout constraints, the Event Count metric 3000A may employ one or more of the following formatting strategies: truncation, horizontal scroll, abbreviation, and auto-expansion—the features of each of the foregoing being previously described above.

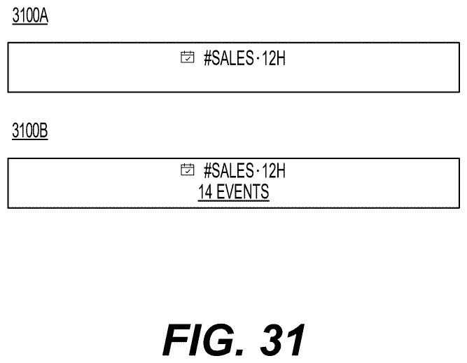

As shown in FIG. 31, the Event Count metric 3100A may be configured to display the total tagged event hours as its primary metric. This configuration may enable users to track the cumulative amount of time associated with calendar events that match a specific tag (e.g., “#sales”) within the active view. This is the inverse of the standard event count display illustrated in FIG. 30, e.g., instead of emphasizing how many tagged events exist, the Event Count metric 3100A foregrounds how much time is consumed by those events. In the default state, the Event Count metric 3100A may appear with: a calendar icon, the configured tag (e.g., “#sales”), and a formatted duration value (e.g., “12 h” or “9 h 30 m”), rounded to the nearest five-minute increment for clarity. This configuration may help users monitor time investment by category or theme, complementing frequency-based insights with duration-based awareness for better scheduling, capacity planning, or retrospective analysis. When the user hovers over the Event Count metric 3100A where the total tagged event hours is configured as the primary display, the component may transition into a hover state that reveals the total number of tagged events present in the current calendar view, as shown in Event count metric 3100B. In an aspect, a secondary line of text may appear beneath the main time value (e.g., “12 h”), showing the total number of matching events as a hyperlink-style label (e.g., “14 events”). In an aspect, when the primary display is set to total tagged event hours, hovering over the Event Count metric 3100B may not only reveal the secondary count line, but it may also trigger highlighting of all calendar events that match the selected tag (e.g., “#sales”) in the current view. This behavior may mirror the highlighting logic used for number of tagged events as primary display, as previously described above. In an aspect, clicking on the Event Count metric 3100B may transition the component into a pressed state, which may anchor the interaction and modify both the metric and the calendar state. The corresponding tag may also be automatically selected in the tag bar, ensuring synchronized filtering and reinforcing the interaction context. In an aspect, the same rules regarding view-based scope (e.g., Day, Week, Weekend, and Month) and display fall backs apply equivalently, as previously described above with respect to Event Count metric 3000A.

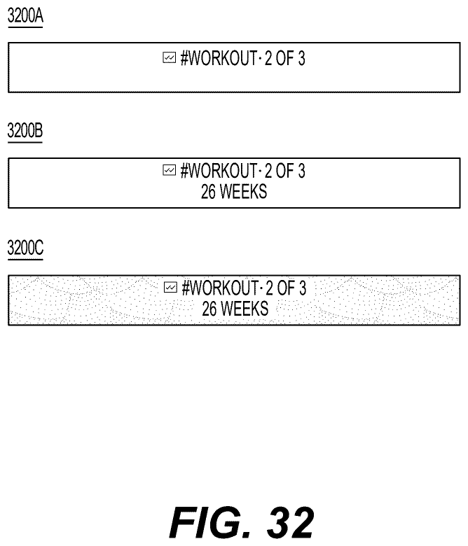

As illustrated in FIG. 32, the Streak metric 3200A may enable users to track their progress toward goal-based recurring tasks associated with a specific tag (e.g., “#workout,” “#meditate,” “read”). This metric may offer a clear, compact visual summary of current performance relative to a predefined target within a given timeframe. In an aspect, the Streak metric 3200A may display a tag name and a completion ratio indicating how many times the associated task has been completed versus the user-defined target (e.g., “2 of 3”). This functionality may support habit formation, wellness tracking, and/or productivity monitoring by enabling users to set goals, such as: “Workout at least 4 times per week,” “madidate 15 times per month, “Journal daily for 7 days”). In an aspect, each streak may be based on events or tasks tagged with a specific label and may be configured with a recurrence frequency (e.g., weekly, monthly).

In its default view, the Streak metric 3200A may display the current count of completed instances versus the total target count for the applicable time period. For example, “2 of 3” may indicate that 2 completed items have been logged out of a 3-task weekly goal. When the user hovers over the Streak Metric 3200A, the component may transition into a hover state that displays the duration of the user's current active streak, measured in consecutive time periods (e.g., weeks or months) during which the goal has been met, as illustrated in Streak metric 3200B. In an aspect, a secondary line of text may appear beneath the main progress indicator, displaying the length of the current streak in a natural language format (e.g., “26 weeks” for a weekly goal streak sustained for 26 consecutive weeks or “3 months” for a monthly goal streak. In an aspect, the streak duration may be calculated by evaluating back-to-back periods during which the user completed the goal as defined (e.g., hitting 3 or 3 workouts weekly).

As shown in user interface 3200C, when a user clicks on a Streak metric, the component may enter a selected state, thereby being visually distinguished by a highlighted background treatment, indicating that the streak has been activated for direct navigation. Upon activation, the system may perform the following logic operations. For instance, the user may be programmatically directed to the next unchecked (incomplete) occurrence of the recurring task associated with the streak (e.g., a “#workout” task scheduled later this week but not yet marked complete). If there are no remaining uncompleted instances of the streak task for the current period, the system may default to navigating the user to the most recent (last) event completed occurrence. In an aspect, the target task may surface within its most contextually relevant location, and may follow this priority sequence: if the task is currently surfaced in the user's UpNext view, it will be shown there; if the task resides within a project, the system may open the project and scroll to the task; if the task is part of a folder but not explicitly part of a project, the folder context may be loaded; if none of the above apply, the system may default to the All Tasks view with the task surfaced in-place. If the task's date falls outside the current view, pagination or scrolling up may be used to load and anchor the task in the correct chronological position.

In an aspect, the Streak metric may be customizable, allowing users to define and track progress toward recurring goals using task-based tags. For instance, for tag selection, users may designate a task tag (e.g., “#workout,” “#meditate”) that may be used to track the completion of recurring goals. A clarification may be presented to ensure users understand that the streak logic applies only to tasks, not to calendar events or event tags. In another example, for tag creation fallback, if the user selects or types a tag that does not yet exist, the system may automatically generate a new task in the Up Next view, pre-populated with the selected tag. Additionally, the same may open the task manager sidebar, focusing on the new task, with the tag field already populated, and allow the user to name and save the task. In another example, for goal definition, users may configure their target behavior using various parameters, including by repetition target (e.g., specify the number of times a tagged tasks may be completed) and/or by time interval (e.g., Daily, Weekly, Monthly, or Custom).

In an aspect, the mini-metric for Streak may not be affected by the user's current calendar view. It may always reflect the user's configured streak goal and current progress relative to that goal, regardless of whether the user is viewing a day, week, month, or other custom range in the calendar. In an aspect, to ensure consistent and accessible display behavior across a wide range of configurations, the Streak metric 3200 may include one or more of the following operations associated with various circumstances. For instance, if the tag name exceeds the maximum display width, the tag may be truncated with ellipses and/or alternative interfaces allow scrolling, abbreviation, or container auto-expansion depending on screen size. As another example, for streaks that track high-volume or cumulative goals (e.g., “10,000 steps per day” or “100 sessions per month”), the display system may support: font size reduction, horizontal scrolling, abbreviated formatting, and dynamic width adjustment of the streak metric container to accommodate wide content without clipping or overflow errors.

### Dark Mode

In an aspect, all visual components and functional elements described herein, including metrics, hover states, pressed states, tooltips, modals, and tag highlights, may be designed to support a corresponding dark mode version. Visual treatments (e.g., background colors, text contrast, and highlight states) may be adjusted to ensure optimal readability, accessibility, and aesthetic consistency when dark mode is enabled.

### Additional Support Features

In an aspect, the system may include an integrated time blocking feature that enables users to reserve portions of their remaining Free Time or Focus Time directly from the calendar interface. In an aspect, time blocking functionality may be available exclusively in Day view and Week View. It may not be available in Month View to preserve layout clarity and prevent interaction conflicts with condensed calendar calls. In an aspect, when the user hovers over either the Free time or Focus Time metric in the metrics bar, the system may display silhouetted placeholders on the calendar, visually indicating the time slots that may be eligible for blocking. These silhouettes may be responsive to the configured work hours and tagged availability rules for each metric. In an aspect, if the user has deleted the default tags associated with the Free Time or Focus time metrics, the corresponding metric may remain visible in the metrics bar. Additionally or alternatively, the metric may continue to be fully interactive, e.g., clicking it may still present all eligible time slots for blocking. Additionally or alternatively, if the user proceeds to block time, the system may automatically recreate the necessary tag in the backend. This may ensure continuity of metric tracking and restores the tag's functionality without manual reconfiguration by the user. This self-repairing mechanism may ensure robust user experience and metric continuity, even when core tags are removed or unintentionally deleted.

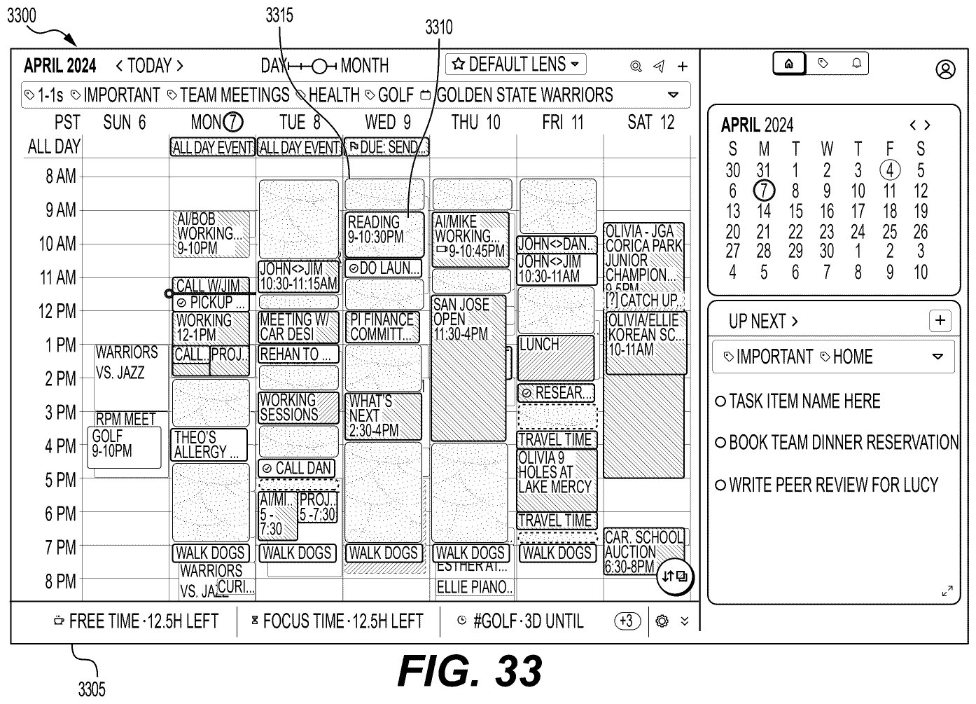

Turning now to user interface 3300 in FIG. 33, when the user hovers over the Free Time metric 3305 in Week View, the system may dynamically update the main calendar canvas to visually guide the user in identifying potential time blocks and existing tagged events. For instance, all scheduled events explicitly tagged with “#freetime” 3310 may be highlighted in a particular color (e.g., a reserved visual style used to reinforce the “Free Time” context). These events may remain fully visible, retaining their title and border styling. For example, the event 3310 titled “Reading” in user interface 3300 is tagged as “#freetime” and is therefore highlighted accordingly. In an aspect, the system may scan for open, unbooked time slots that occur within the user's configured Free Time hours, as defined in their preferences (e.g., 8:00 AM-6:00 PM). All eligible time blocks, e.g., periods not overlapping with commitment events, may be displayed as cross-hatched regions 3315 rendered with the same particular color as was used to highlight the “Reading” event. The cross-hatched regions 3315 may be configured to not obstruct existing content, but remain visually distinct from standard empty grid spaces. This hover-based visualization may facilitate an intuitive preview of actionable on the calendar, helping users locate free space without scanning manually or triggering popovers.

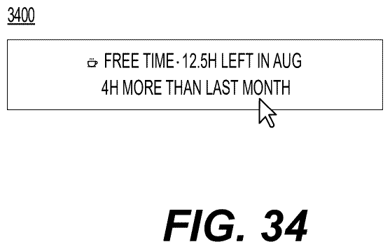

As illustrated in FIG. 34, when the user hovers over the Free Time metric 3400 while in Month View, the system may not present cross-hatched time block overlays or scheduling silhouettes. Instead, the hover behavior in this context may provide a summary-based comparison view directly within the metric bar component. More particularly, upon hover, the Free Time metric 3400 may be updated with the following information: the current month's Free time summary (e.g., the main line may continue to show the total amount of Free Time remaining for the current month in view, e.g., “Free Time—12.5 h left in Aug”) and comparative context against previous month (e.g., a secondary line of text may appear beneath the main metric, offering a comparative insight to the user's previous month's Free Time, e.g., “4 h more than last month”).

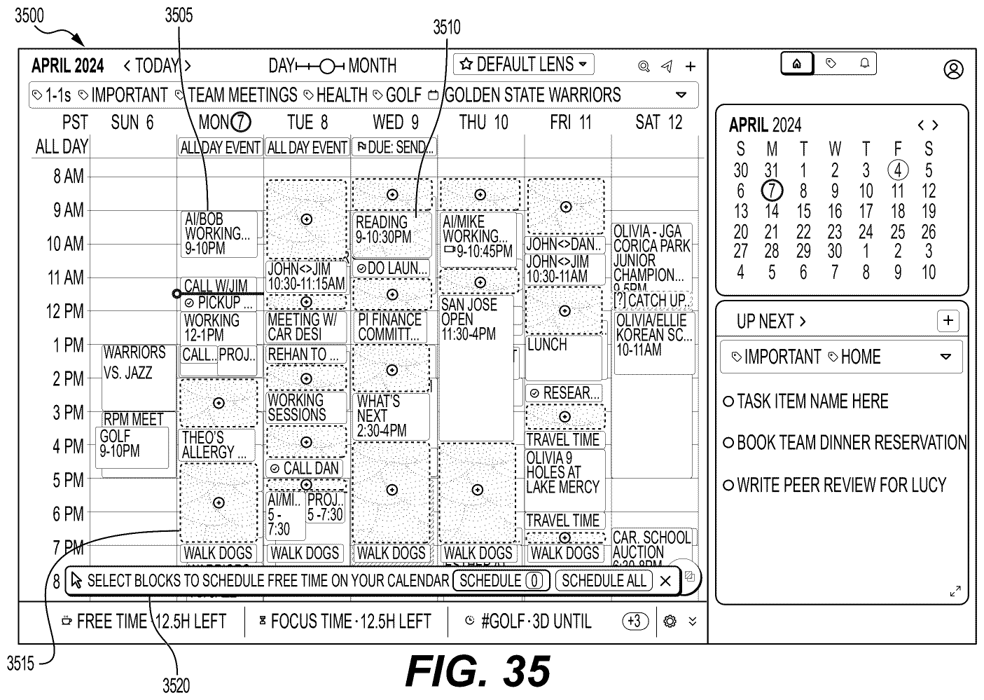

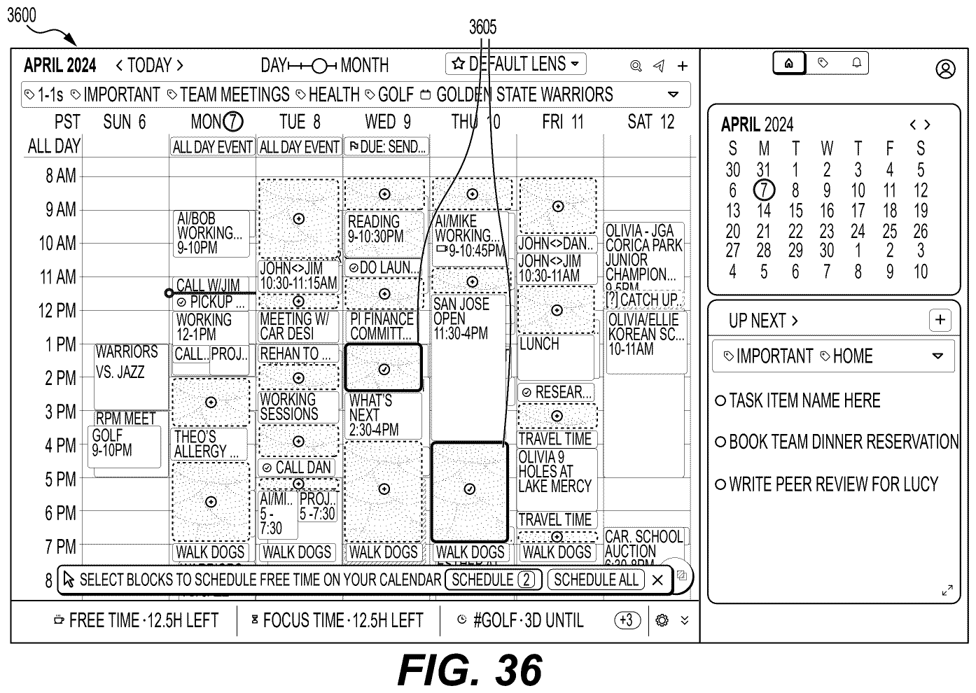

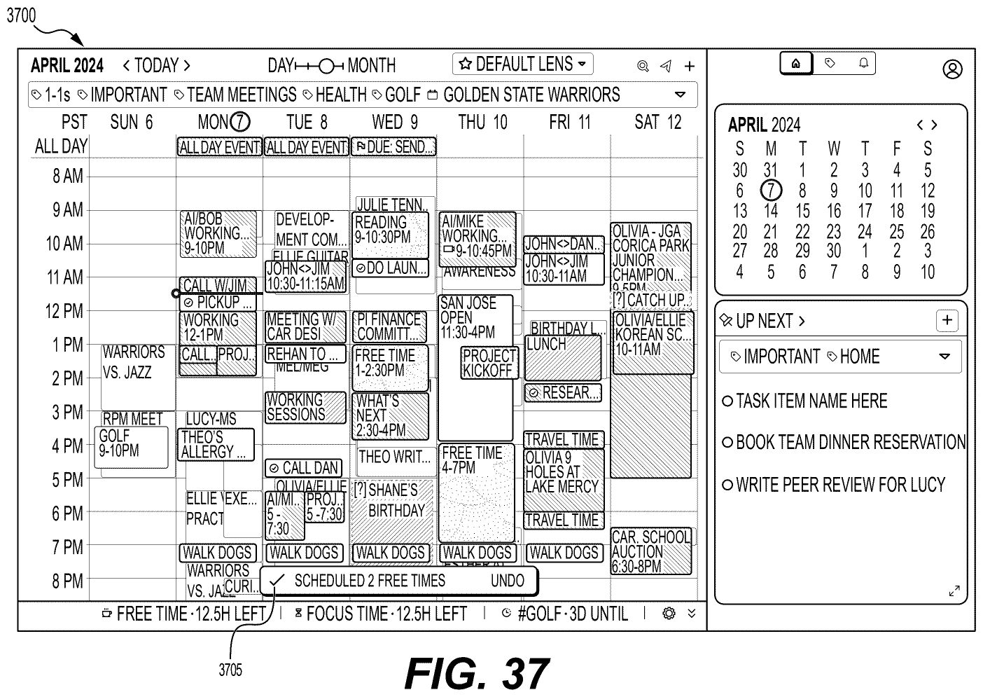

Turning now to user interface 3500 in FIG. 35, when the user clicks on the Free Time metric button while in Day View or Week View, the system may transition into a pressed state to support interactive time blocking. In this regard, all existing events 3505 may be dimmed and visually pushed to the background, creating a subdued visual layer. The only exceptions may be events that are explicitly tagged with “#freetime,” which remain fully visible in the foregoing and retain standard color and formatting (e.g., the event 3510 titled “Reading”). In an aspect, all identified blocks of unbooked time 3515—those that do not overlap with commitment events and fall within the user's configured Free Time hours—may be rendered with the following properties: red cross-hatched fill, a dotted-line outline to visually differentiate them as selectable regions, and a centered “+” icon indicating interactivity and suggesting the ability to schedule or add content. In an aspect, a schedule toolbar 3520 may appear on user interface 3500 that presents scheduling options such as: “Schedule [X]” to convert selected time blocks into scheduled Free Time events, “Schedule all” to reserve all available Free Time blocks in the current view, and “Cancel” or “X” to exit pressed mode and return to the default calendar view. Turning now to FIG. 36, when the user clicks or taps on a specific time block, the visual styling of that block transitions into a “checkmark state,” e.g., blocks 3605, which are represented by a solid fill color and a centered checkmark icon replacing the “+” icon. The system may increment the internal counter tracking selected blocks, and the Schedule X button may be immediately updated to reflect the new count (e.g., if two blocks are selected, the button will read: “Schedule 2,” as shown in FIG. 36). Upon activation of either scheduling action, the system may create a new calendar event for each selected block. For instance, each event may be titled “Free Time” or “Focus Time” depending on which metric triggered the flow, and each event may be applied a default visual style consistent with the other scheduled events, as shown in FIG. 37. Additionally, each event may be automatically tagged with “#freetime” or “#focustime,” ensuring proper classification for future metric calculations. After events are successfully added to the calendar, a toast notification 3705 may appear at the bottom of the screen containing a message, e.g., “Scheduled X free time events,” as shown in FIG. 37. An undo option may be presented alongside the message, allowing the user to reverse the action immediately.

The system may contain similar scheduling functionality with “Focus Time” as it does with “Free Time,” shown in FIGS. 35-37 and elaborated upon above.

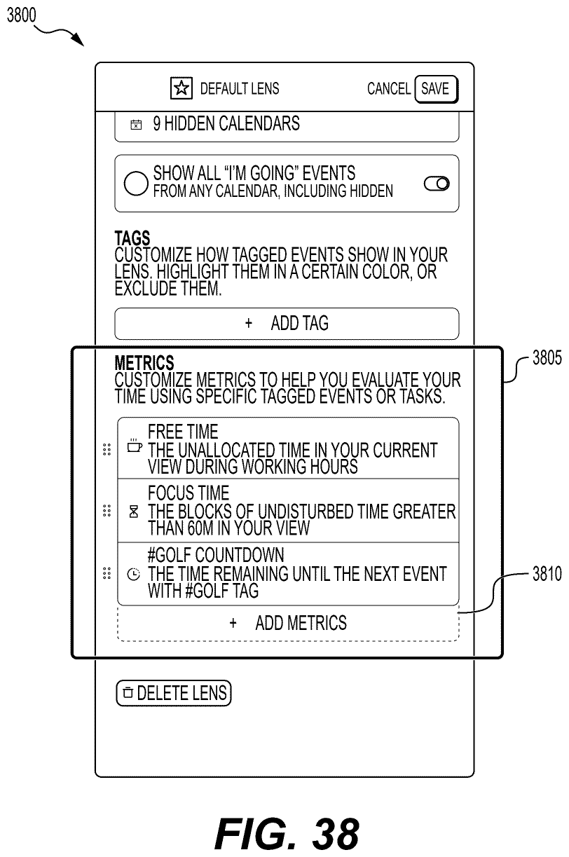

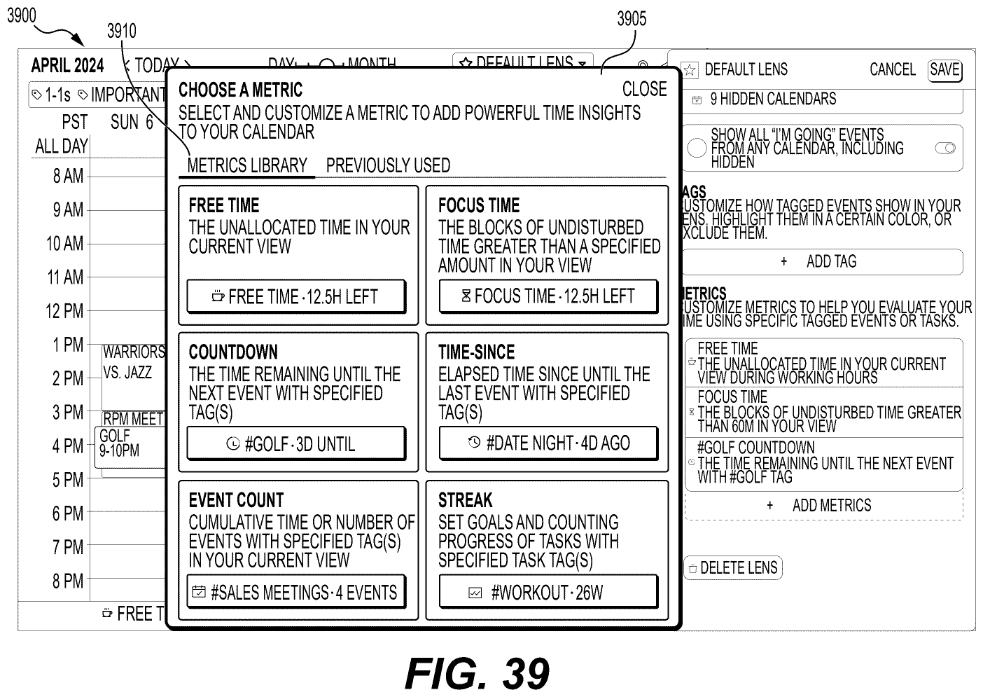

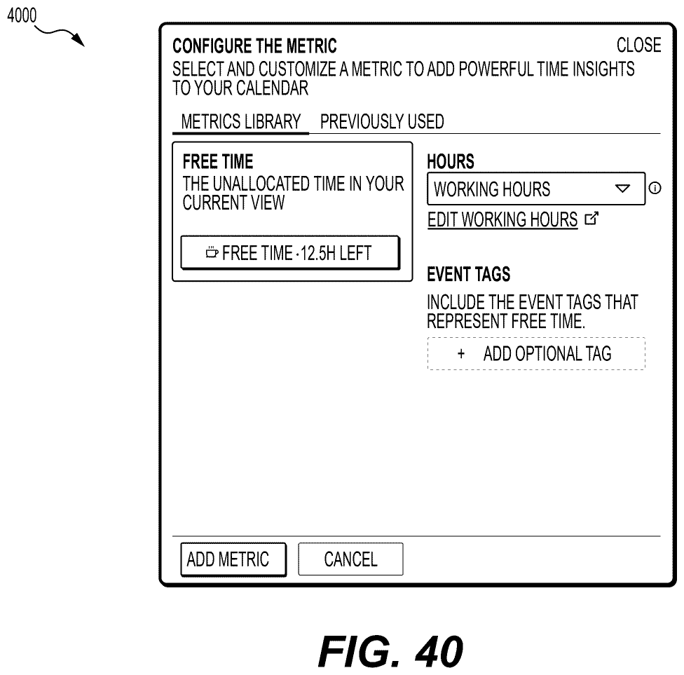

Turning now to FIG. 38, a Manage Lenses sidebar interface 3800 is presented, in which users may be provided the ability to define which metrics appear in the metrics toolbar for each individual lens. A metrics configuration panel 3805 may allow users to customize the analytics surfaced by the lens. Each metric selected for inclusion may be displayed in a vertically stacked card layout and may each include: the metric name, a short description summarizing the calculation logic or the scope of the metric, and, if the metric is tag-based, the associated tag name rendered with a leading hashtag and consistent tag styling. In an aspect, users may reorder metrics via drag handles present on each card, which controls their left-to-right order in the metrics toolbar. Users may also remove a metric by interacting with a contextual delete or remove control (not visible in this image). In an aspect, users may add a new metric by clicking the “add metric” button 3810 at the bottom of the metrics configuration panel 3805, which opens a metric creation or selection model. For instance, turning now to FIG. 39, user interface 3900 may contain a popover modal 3905 that allows the user to select from available metric types. The user may interact with a Metrics Library 3910 present in the popover modal 3905, which displays a curated list of metric types that the user can add to the current lens. Available metric types may include, but are not limited to: Free Time, Focus Time, Countdown, Time Since, Event Count (number of events or total hours), and Streak. In an aspect, upon selecting a metric from the Metrics Library 3910 (e.g., “Free Time”), the system may present the user with a configuration model, as shown by configuration model 4000 in FIG. 40, which is a popover interface that enables customization of the selected metric's parameters before adding it to the lens. Within the configuration model 4000, a metric summary panel may be presented that contains the metric name and short description and a live preview of how the metric may appear in the metrics toolbar. The configuration model 4000 may also contain a configuration panel, that includes settings specific to the selected metric. For instance, in the case of the “Free Time” metric, hours and event tag options may be present. In an aspect, clicking the “add metric” button may validate the selected inputs, add the configured metric to the metrics section of the currently active lens, and close the modal and return the user to the lends editing view. In the Manage Lens sidebar interface 3800, when the user clicks the “Save” button, the selected metrics may be persisted and reflected immediately in the main metrics toolbar associated with that lens.

Elaborated on below are various configuration options available for each metric type (e.g., that the user may configure by interacting with a dedicated version of configuration model 4000).

In an aspect, The Free Time metric may be configured to operate exclusively within the user's defined working hours. The Free Time metric may calculate available time by evaluating the absence of scheduled events during those hours, while also incorporating any events explicitly tagged with “#freetime.” This tag may be a predefined system tag and may be the sole tag permitted for this metric. The configuration interface (e.g., presented in configuration model 4000) will not allow users to add or modify tags. To avoid confusion, a clear notice may be displayed stating that custom tags are not supported and that only events tagged with #freetime will contribute to the metric's calculations. Additionally, the system may inform users that such tagged events will still be counted toward the Free Time metric even if scheduled outside the designated working hour range. In an aspect, an optional alerts toggle may be available (not illustrated) that, when selected, may provide the user with an alert when their free time is below a specified amount of time. In some aspects, the user may explicitly designate the threshold amount of time that, below which, an alert may be issued (e.g., “Warn me when my #free time is below 16 hours per week).

In an aspect, the Focus Time metric may similarly operate strictly within working hours and may be designed to identify uninterrupted blocks of time suitable for deep work. A configurable numeric field may allow users to define the minimum length of time that qualifies as a focus block, with the default set to 60 minutes. The input field must accept whole numbers ranging from 1 to 1440, representing any duration from one minute up to a full day. In addition to detecting gaps in the schedule, the Focus Time metric may include events tagged with #focustime, which is also a system-issued, non-editable tag. Custom tags are not allowed. As with Free Time, users must be informed that any events tagged with #focustime will be included in the calculation, regardless of whether they occur within or outside of the configured working hours. In an aspect, an optional alerts toggle may be available (not illustrated) that, when selected, may provide the user with an alert when their available focus time is below a specified amount of time. In some aspects, the user may explicitly designate the threshold amount of time that, below which, an alert may be issued (e.g., “Warn me when my #focus time is below 16 hours per week).

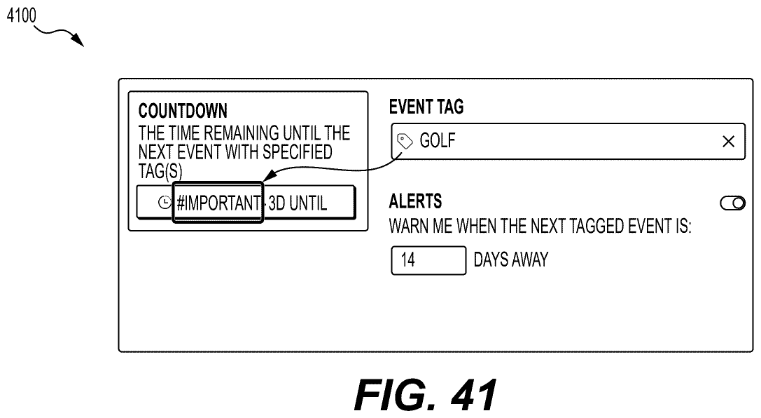

In an aspect, the Countdown metric may enable users to track the time remaining until the next scheduled calendar event associated with a specified tag, and its configuration interface (e.g., interface 4100 in FIG. 41) may include a set of constrained and intuitive controls. Users may assign only one event tag per Countdown metric via a labeled tag input field, with behavior that either prevents the addition of a second tag or replaces the current tag based on implementation. Users may select from existing tags via auto-complete or create a new one inline, and the selected tag may be displayed as a chip with an “X” button for removal. Upon tag selection, the metric preview card may dynamically update to show the selected tag and corresponding time remaining (e.g., #golf·3 d until). An optional Alerts toggle may let users enable a numeric input field, e.g., labeled “Warn me when the next tagged event is: [X] days away,” supporting only whole numbers between 1 and 999, with 14 as the default. Invalid entries may trigger inline validation messages. When enabled, alerts may trigger front-end notifications if the next event is within the defined threshold. The preview area, located on the left of the modal, may reflect all changes in real-time, including the selected tag and the calculated time remaining. At the bottom of the configuration interface, selection of the Add Metric button applies the configuration to the selected Lens, while the Cancel button closes the modal without saving.

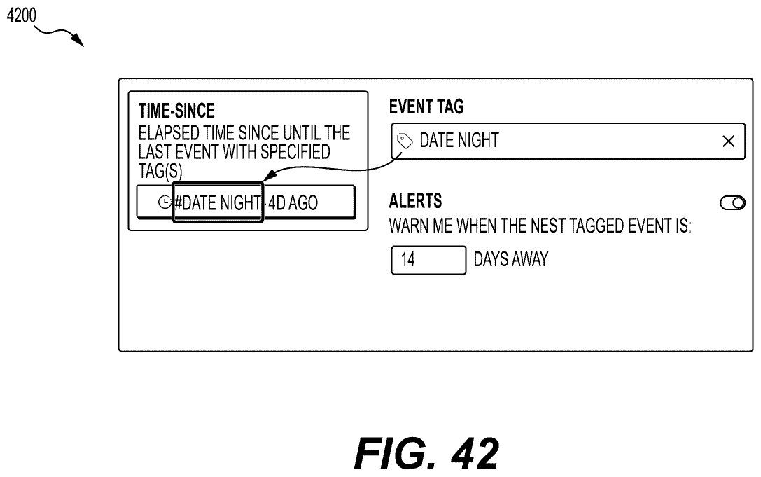

In an aspect, the Time Since metric may enable users to track the elapsed time since the last event associated with a designated tag and includes a configuration interface (e.g., interface 4200 in FIG. 42) with specific behavioral constraints. Users may select or create a tag via a labeled input field, choosing from existing tags using auto-complete or by entering a new one. Only one tag may be applied per metric; attempts to add more will either replace the current tag (preferred) or be blocked with a tooltip. Once selected, the tag may appear as a chip-style element with a removable “X” icon (e.g., “date night”), and the metric preview on the left may dynamically update to show the formatted tag (e.g., #datenight) and the real-time elapsed duration since the most recent event (e.g., 4d ago). An optional Alerts toggle may allow users to specify a threshold with the label “Warn me when the last tagged event is: [X] days past,” accepting whole numbers between 1 and 999 (default: 14); if the elapsed time exceeds this threshold, a frontend or in-app alert may be triggered, depending on implementation. The live preview area may continuously reflect updates to the tag and time values. The Add Metric button saves the configuration to the active Lens, while the Cancel button exits the modal without saving.

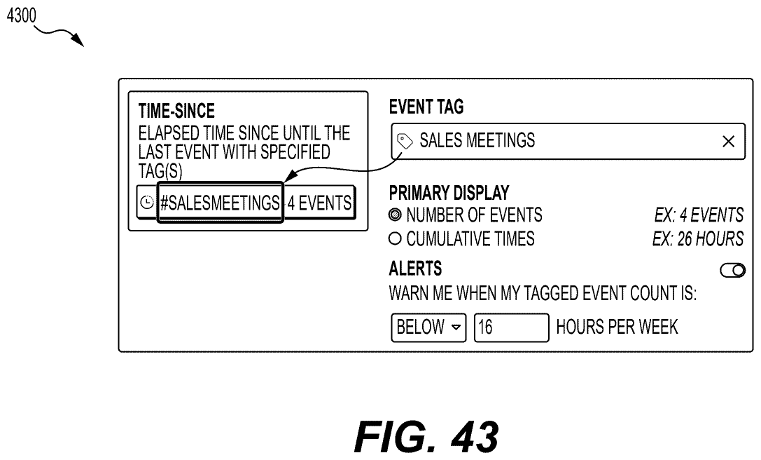

In an aspect, the Event Count metric may allow users to monitor either the number of scheduled events or the total time spent in events associated with a specific tag, offering configurable options to tailor the metric's behavior. Users may interact with a configuration interface (e.g., interface 4300 in FIG. 43) to select or create a tag via the Event tag input field, choosing from existing options in a dropdown or entering a new tag (e.g., “sales meetings”). Once selected, the tag may appear as a chip in the input field, and the preview area to the left may dynamically display the tag in hashtag format (e.g., #salesmeetings) along with a live calculation of either the number of events or total hours, depending on the selected display mode. Users may choose the Primary display type using a radio button group, with the default set to “Number of Events” (e.g., 4 events) or optionally “Cumulative Time” (e.g., 26 hours). Only timed events—those with defined start and end times—may be included; all-day events may be explicitly excluded from both count and duration calculations. An optional Alerts toggle may enable users to configure a rule such as “Warn me when my tagged event count is: Below 16 hours per week,” using dropdowns for condition type (“Above” or “Below”), threshold input, and frequency window (“events” or “hours per week”). The Metric Preview updates in real time to reflect all selections, including tag name, display type, and metric values. Once configuration is complete, the user may click Add Metric to apply the metric to the active Lens or select Cancel to discard changes.

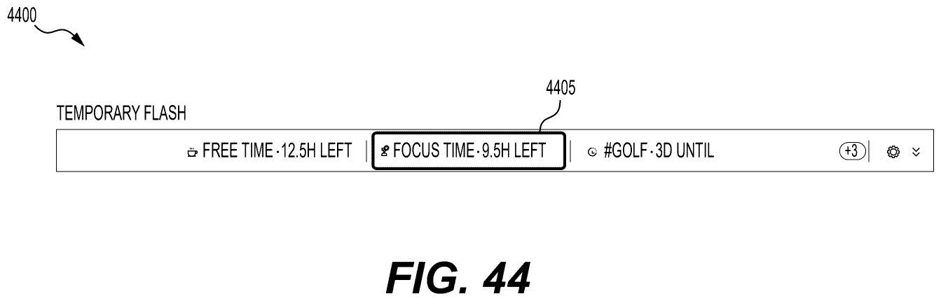

In an aspect, upon the creation of a new event, the system may automatically evaluate whether the updated state of the user's calendar violates any active Metric Alert conditions configured for the current view. If an alert condition is met—such as the user's available Focus Time dropping below a specified threshold—the affected metric in the Metrics Toolbar may immediately respond with a visual flash, briefly highlighting the metric in a light red background to draw the user's attention, as shown by the metrics toolbar 4400 in FIG. 44. In addition to this temporary animation, the metric 4405 may display a persistent red dot badge affixed to the left of the metric label. This red dot serves as an ongoing visual indicator that the alert threshold remains unmet. The red dot may only be cleared from the metric once the triggering condition is resolved, such as by scheduling additional time or modifying the alert threshold in the configuration settings. These visual cues may be designed to ensure the user is made aware of any deviations from their set goals or limits without requiring them to navigate away from the main interface.

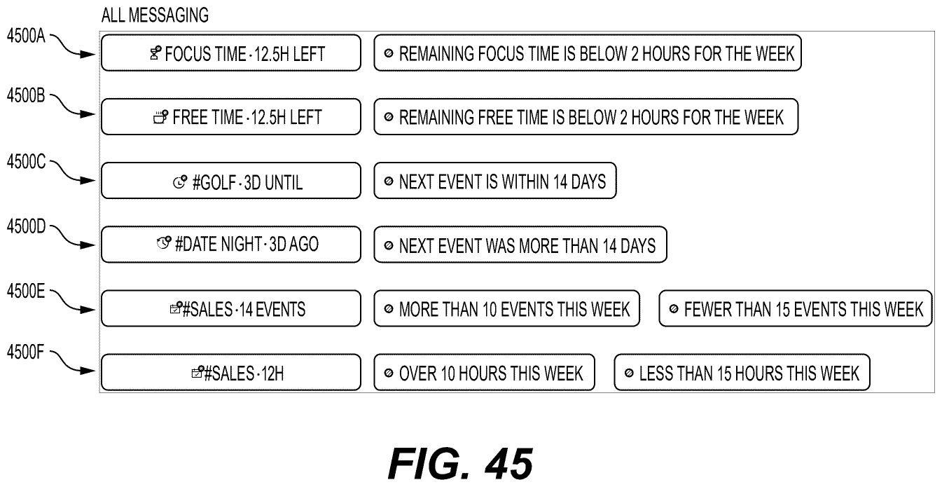

In an aspect, when a metric is in an alert state, e.g., indicated by a persistent red dot badge adjacent to the metric label, the system may provide contextual feedback to the user through hover messaging. As shown in 4500A-4500F in FIGS. 45A-45F, when the user hovers their cursor over a metric in alert mode, a black tooltip map appear, providing a clear explanation for the alert. This tooltip content may be dynamically generated based on the metric type and the specific alert condition that was triggered.

It should be understood that embodiments in this disclosure are exemplary only, and that other embodiments may include various combinations of features, as well as additional or fewer features, may be utilized. For example, some calendaring applications may leverage all of the concepts associated with “layers,” “tags,” “lenses,” “rules,” and “metrics,” whereas other calendaring applications may incorporate some subset of the foregoing features.

In general, any process or operation discussed in this disclosure that is understood to be computer-implementable may be performed by one or more processors of a computer system, such as any of the systems or devices in system 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as system environment 100, may include one or more computing devices. If the one or more processors of the computer system are implemented as a plurality of processors, the plurality of processors may be included in a single computing device or distributed among a plurality of computing devices. If a system environment comprises a plurality of computing devices, the memory of the computer system may include the respective memory of each computing device of the plurality of computing devices.

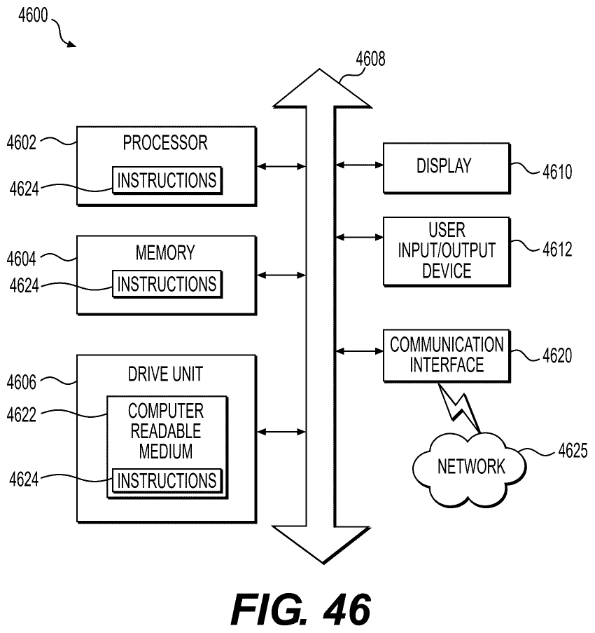

FIG. 46 is a simplified functional block diagram of a computer system 4600 that may be configured as a computing device for executing the processes described herein, according to exemplary embodiments of the present disclosure. In various embodiments, any of the systems herein may be an assembly of hardware including, for example, a data communication interface 4620 for packet data communication. The platform also may include a central processing unit (“CPU”) 4602, in the form of one or more processors, for executing program instructions. The platform may include an internal communication bus 4608, and a storage unit 4606 (such as ROM, HDD, SDD, etc.) that may store data on a computer readable medium 4622, although the system 4600 may receive programming and data via network communications via electronic network 4625 (e.g., voice, video, audio, images, or any other data over the electronic network 4625). The system 4600 may also have a memory 4604 (such as RAM) storing instructions 4624 for executing techniques presented herein, although the instructions 4624 may be stored temporarily or permanently within other modules of system 4600 (e.g., processor 4602 and/or computer readable medium 4622). The system 4600 also may include input and output ports 4612 and/or a display 4610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that the disclosed embodiments may be applicable to any environment, such as a desktop or laptop computer, a laboratory computing system, an office computing environment, etc. Also, the disclosed embodiments may be applicable to any type of Internet protocol.

It should be appreciated that in the above description of exemplary embodiments of the disclosure, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of this disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of this disclosure, and it is intended to claim all such changes and modifications as falling within the scope of this disclosure. For example, functionality may be added or deleted from the various calendaring interface and operations may be interchanged between them. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer system for managing metrics on a data management application, the computer system comprising:
at least one processor;
a user interface configured to present an electronic data management application and a metrics toolbar; and
at least one memory storing instructions that are executable by the at least one processor, wherein the instructions cause the at least one processor to:
receive a user selection of a metric type from a predefined set of metric types;
receive one or more configuration parameters associated with the selected metric type; and
generate a visual representation of the configured metric within a metrics toolbar presented on the electronic data management application, wherein the visual representation comprises a computed metric value based on scheduled event data and the configuration parameters.

2. The computer system of claim 1, wherein the predefined set of metric types comprises one or more of: a free time metric, a focus time metric, a countdown metric, a time since metric, an event count metric, and a streak metric.

3. The computer system of claim 1, wherein the one or more configuration parameters comprise one or more of: a tag identifier, a time range, and a threshold value.

4. The computer system of claim 1, wherein the instructions are further executable by the at least one processor to:
detect when a metric value satisfies a predefined alert condition; and
initiate an alert response comprising at least one of: applying a visual highlight to the corresponding metric in the metrics toolbar, presenting a hover-based message, or displaying a persistent symbol.

5. The computer system of claim 1, wherein the instructions are further executable by the at least one processor to:
generate, in response to a user selection of an available time block from the electronic data management application associated with a displayed metric, a new event corresponding to the displayed metric; and
apply a predefined tag to the displayed metric.

6. The computer system of claim 1, wherein the electronic data management application is viewable in a plurality of formats, comprising: a day view format, a week view format, a month view format, and a weekend view format.

7. The computer system of claim 1, wherein the instructions are further executable by the at least one processor to:
adjust one or more display characteristics of one or more metrics presented on the metrics toolbar based on available screen width.

8. The computer system of claim 1, wherein the instructions are further executable by the at least one processor to:
identify an active view context of the user as generated based on a selected lens on the electronic data management application; and
configure one or more metrics presented on the metrics toolbar based on the identified active view context.

9. The computer system of claim 1, wherein the instructions are further executable by the at least one processor to:
recalculate and refresh displayed metric values in response to the creation, modification, or deletion of events in the electronic data management application.

10. The computer system of claim 1, wherein the instructions are further executable by the at least one processor to:
output configured metric data for a specified time range into a report or file configured for access by one or more users.

11. A computer-implemented method for managing metrics on a data management application, the computer-implemented method comprising:
receiving, at a user interface configured to present an electronic data management application and a metrics toolbar and using a processor associated with the data management application, a user selection of a metric type from a predefined set of metric types;
receiving, using the processor, one or more configuration parameters associated with the selected metric type; and
generating, using the processor, a visual representation of the configured metric within a metrics toolbar presented on the electronic data management application, wherein the visual representation comprises a computed metric value based on scheduled event data and the configuration parameters.

12. The computer-implemented method of claim 11, wherein the predefined set of metric types comprises one or more of: a free time metric, a focus time metric, a countdown metric, a time since metric, an event count metric, and a streak metric.

13. The computer-implemented method of claim 11, wherein the one or more configuration parameters comprise one or more of: a tag identifier, a time range, and a threshold value.

14. The computer-implemented method of claim 11, further comprising:
detecting, using the processor, when a metric value satisfies a predefined alert condition; and
initiating and alert response comprising at least one of: applying a visual highlight to the corresponding metric in the metrics toolbar, presenting a hover-based message, or displaying a persistent symbol.

15. The computer-implemented method of claim 11, further comprising:
generating, using the processor and in response to a user selection of an available time block from the electronic data management application associated with a displayed metric, a new event corresponding to the displayed metric; and
applying, using the processor, a predefined tag to the displayed metric.

16. The computer-implemented method of claim 11, wherein the electronic data management application is viewable in a plurality of formats, comprising: a day view format, a week view format, a month view format, and a weekend view format.

17. The computer-implemented method of claim 11, further comprising
identifying, using the processor, an active view context of the user as generated based on a selected lens on the electronic data management application; and
configuring, using the processor, one or more metrics presented on the metrics toolbar based on the identified active view context.

18. The computer-implemented method of claim 11, further comprising:
recalculating and refreshing, using the processor, displayed metric values in response to the creation, modification, or deletion of events in the electronic data management application.

19. The computer-implemented method of claim 11, further comprising:
outputting, using the processor, configured metric data for a specified time range into a report or file configured for access by one or more users.

20. At least one non-transitory computer-readable medium storing instructions for managing metrics on a data management application, the instructions, when executed by at least one processor, causing the at least one processor to perform operations comprising:
receiving, at a user interface configured to present an electronic data management application and a metrics toolbar, a user selection of a metric type from a predefined set of metric types;
receiving one or more configuration parameters associated with the selected metric type; and
generating a visual representation of the configured metric within a metrics toolbar presented on the electronic data management application, wherein the visual representation comprises a computed metric value based on scheduled event data and the configuration parameters.
